(19) United States
(12) Patent Application Publication
(10) Pub. No.: US 2026/0310582 A1
(43) Pub. Date: Oct. 8, 2026

(54) Automated Code Compliance Review and Correction of Computer-Generated Architectural Drawings

(71) Applicant: Rendzie, LLC, Miami Beach, FL (US)

(72) Inventors: John William Carr, Miami Beach, FL (US); Brian Galvin, Silverdale, WA (US)

(21) Appl. No.: 19/709,363

(22) Filed: Jun. 16, 2026

Related U.S. Application Data
(63) Continuation-in-part of application No. 18/399,496, filed on Dec. 28, 2023, now Pat. No. 12,657,353.

(51) Int. Cl. G06F 11/3668

(52) U.S. Cl. CPC G06F 11/3672

(57) ABSTRACT

A platform for architectural drawing generation and approval with automated code compliance review and correction. The platform generates 3D architectural images from text descriptions, question and answer templates, and/or sample images for user or designer review and approval, and converts the verified 3D architectural images to 2D architectural drawings for permitting and construction. A code compliance and correction module receives the output 2D architectural drawings, selects a jurisdiction-specific code set from a multi-jurisdiction code database based on a project location, and analyzes the drawings using a machine learning algorithm trained on labeled architectural drawings associated with code compliance determinations. Detected violations are spatially marked within the drawings and reported with applicable code sections and suggested corrections, and the drawings are iteratively corrected until all applicable code requirements are satisfied, with design changes propagated upstream for regeneration of the 3D architectural images.

### CROSS-REFERENCE TO RELATED APPLICATIONS

Priority is claimed in the application data sheet to the following patents or patent applications, each of which is expressly incorporated herein by reference in its entirety: 18/399,496

### BACKGROUND OF THE INVENTION

### Field of the Art

The present invention is in the field of engineering and construction, and more particularly in the field of computer-aided design of architectural drawings.

### Discussion of the State of the Art

Creation of architectural drawings and images is currently a laborious process requiring substantial skill and expertise. Software tools exist which facilitate drawing of two-dimensional (2D) architectural drawings, but these tools take much time and dedication to learn. It is not possible for casual users and inexperienced users (homeowners, for example) to use them with any competence without days or weeks of training or self-learning. Thus, casual users and inexperienced users are unable to generate 2D architectural drawings of their intended designs without hiring a professional to generate them. Professionals must dedicate large amounts of time to architectural drawing generation, and then spend more time applying for permits and interacting with government officials to push the permits through. This leads to substantial construction delay and additional cost before construction can begin.

While some of the software tools mentioned above can create three-dimensional images (3D) of an intended design, they require exacting and detailed 2D architectural drawings as inputs, created using their own proprietary drawing tools. Artificial intelligence (also known as machine learning) based image generators have been created recently which can generate images from informal text descriptions, but as the output of these image generators depends entirely on the training inputs to the machine learning algorithm(s), the user has no control over the accuracy, consistency, or usefulness of the outputs for purposes of generating images of architectural designs.

Further, even where 2D architectural drawings can be produced, obtaining approval of those drawings from government permitting authorities remains a slow, manual, and error-prone process. The building codes applicable to a given construction project vary by jurisdiction, and a single project may be subject to overlapping municipal building codes, county requirements, state codes, model code provisions such as those of the International Building Code (IBC), and fire codes, which may impose conflicting requirements. Compliance review of architectural drawings against these codes is performed manually by plan examiners and code officials, and many compliance failures, such as insufficient egress path widths, rooms that do not satisfy minimum area requirements, and structures that violate setback requirements, cannot be detected from a list of design requirements alone, but only from the geometry of the completed drawings themselves. Manual review therefore leads to repeated cycles of rejection, correction, and resubmission, adding further delay and cost before construction can begin.

What is needed is a platform for easy generation of 3D architectural images from text descriptions, question and answer templates, and/or sample images for user or designer review and approval, and conversion of those 3D architectural images to 2D architectural drawings for permitting and construction. What is further needed is automated, jurisdiction-aware review of the generated 2D architectural drawings against applicable building codes, with spatial localization of detected violations within the drawings, and iterative correction of the drawings until compliance is achieved.

### SUMMARY OF THE INVENTION

Accordingly, the inventor has conceived and reduced to practice, a platform for architectural drawing generation and approval which allows for easy generation of 3D architectural images from text descriptions, question and answer templates, and/or sample images for user or designer review and approval, and conversion of those 3D architectural images to 2D architectural drawings for permitting and construction. In an embodiment, the system and method involve generating structured requirements via a question and answer structured template, generating 3D images from a combination of the structured requirements and sample images provided by a user, and generating 2D architectural drawings from the 3D architectural images. In an embodiment, the 2D architectural drawings can be submitted for automated code compliance checking via one or more architectural modeling engines.

According to a preferred embodiment, a system for generating architectural drawings and images from text descriptions is disclosed, comprising: a computing device comprising a memory and a processor; an inputs and requirements analysis portal comprising a first plurality of programming instructions stored in the memory which, when operating on the processor, causes the computing device to: receive an informal text description of an architectural design; convert the informal text description into structured requirements by: parsing the informal text description into its constituent words and phrases; analyze the words and phrases using a natural language processing engine to determine their context; and create a set of structured requirements from the context of the words and phrases, the structured requirements comprising a data structure and data; and send the structured requirements to a three-dimensional (3D) image generation manager and to a two-dimensional (2D) architectural drawing manager; the three-dimensional (3D) image generation manager comprising a second plurality of programming instructions stored in the memory which, when operating on the processor, causes the computing device to: receive the structured requirements; generate a formal text description from the structured requirements using an artificial intelligence (AI) based text generation engine; generate a 3D architectural image by processing the formal text description through an open-source, cloud-based image generation program; verify compliance of the 3D architectural image with the architectural design by receiving input from a human reviewer, wherein: if the input indicates non-compliance, the formal text description is re-generated to correct the non-compliance; and if the input indicates compliance, output the 3D architectural image; the two-dimensional (2D) architectural drawing manager comprising a third plurality of programming instructions stored in the memory which, when operating on the processor, causes the computing device to: receive the structured requirements; generate 2D architectural drawings from the structured requirements by mapping of the data in the data structure to 2D architectural drawing elements; and output the 2D architectural drawing.

According to another preferred embodiment, a method for generating architectural drawings and images from text descriptions is disclosed, comprising the steps of: using an inputs and requirements analysis portal operating on a computing device comprising a memory and a processor to perform the steps of: receiving an informal text description of an architectural design; converting the informal text description into structured requirements by: parsing the informal text description into its constituent words and phrases; analyze the words and phrases using a natural language processing engine to determine their context; and creating a set of structured requirements from the context of the words and phrases, the structured requirements comprising a data structure and data; and sending the structured requirements to a three-dimensional (3D) image generation manager and to a two-dimensional (2D) architectural drawing manager; using the three-dimensional (3D) image generation manager operating on the computing device to perform the steps of: receiving the structured requirements; generating a formal text description from the structured requirements using an artificial intelligence (AI) based text generation engine; generating a 3D architectural image by processing the formal text description through an open-source, cloud-based image generation program; verifying compliance of the 3D architectural image with the architectural design by receiving input from a human reviewer, wherein: if the input indicates non-compliance, the formal text description is re-generated to correct the non-compliance; and if the input indicates compliance, the 3D architectural image is output; using the two-dimensional (2D) architectural drawing manager operating on the computing device to perform the steps of: receiving the structured requirements; generating 2D architectural drawings from the structured requirements by mapping of the data in the data structure to 2D architectural drawing elements; and outputting the 2D architectural drawing.

According to an aspect of an embodiment, an architectural modeling engine is used to: receive a query from the inputs and requirements analysis portal, the query comprising a portion of the data from the structured requirements; determine whether the portion of the data is consistent with a parameter of an architectural model of the architectural modeling engine; and provide a response to the inputs and requirements analysis portal, wherein: if the determination is that the data is consistent with the parameter, the response so indicates; and if the determination is that the data is not consistent with the parameter, the response comprises an architectural constraint.

According to an aspect of an embodiment, the three-dimensional (3D) image generation manager is programmed to perform a second verification of the 3D architectural mage wherein: the 3D architectural image is converted to converted text using an AI-based image-to-text converter; and the converted text is compared to the formal text description using an AI-based text-to-text comparator, wherein: if the comparison falls below a threshold level of likeness, the formal text description is re-generated to increase the level of likeness above the threshold; and if the comparison meets or exceeds the threshold level of likeness, output the 3D architectural image.

According to an aspect of an embodiment, the three-dimensional (3D) image generation manager is programmed to perform a third verification of the 3D architectural mage wherein: the 3D architectural image is analyzed using an AI-based image-to-text converter to determine a subject of the image; and the subject is compared to the formal text description, wherein: if the comparison falls below a threshold level of likeness, the formal text description is re-generated to increase the level of likeness above the threshold; and if the comparison meets or exceeds the threshold level of likeness, output the 3D architectural image.

According to a preferred embodiment, a system for automated code compliance review and correction of computer-generated architectural drawings is disclosed, comprising: a computing device comprising a memory and a processor; a two-dimensional (2D) architectural drawing manager comprising a first plurality of programming instructions stored in the memory which, when operating on the processor, causes the computing device to: receive a verified three-dimensional (3D) architectural image; generate a 2D architectural drawing from the verified 3D architectural image by processing the verified 3D architectural image through a machine learning algorithm which has been trained to generate 2D architectural drawings from a database of labeled training data associating 3D architectural images with their 2D architectural drawing counterparts; and output the 2D architectural drawing; and a code compliance and correction module comprising a second plurality of programming instructions stored in the memory which, when operating on the processor, causes the computing device to: receive the 2D architectural drawing from the 2D architectural drawing manager; select a jurisdiction-specific code set from a multi-jurisdiction code database based on a project location; process the 2D architectural drawing and the jurisdiction-specific code set through a compliance machine learning algorithm which has been trained on a database of labeled training data associating 2D architectural drawings with jurisdiction-specific code compliance determinations, to generate a structured violation report identifying each code violation by violation type, applicable code section, location within the 2D architectural drawing, and one or more suggested corrections; generate an annotated 2D architectural drawing in which each identified violation is spatially marked at its location within the 2D architectural drawing; generate a corrected 2D architectural drawing based on the structured violation report; and re-submit the corrected 2D architectural drawing to the compliance machine learning algorithm and iterate until the corrected 2D architectural drawing satisfies all requirements of the jurisdiction-specific code set.

According to another preferred embodiment, a method for automated code compliance review and correction of computer-generated architectural drawings is disclosed, comprising the steps of: using a two-dimensional (2D) architectural drawing manager operating on a computing device comprising a memory and a processor to: receive a verified three-dimensional (3D) architectural image; generate a 2D architectural drawing from the verified 3D architectural image by processing the verified 3D architectural image through a machine learning algorithm which has been trained to generate 2D architectural drawings from a database of labeled training data associating 3D architectural images with their 2D architectural drawing counterparts; and output the 2D architectural drawing; and using a code compliance and correction module operating on the computing device to: receive the 2D architectural drawing from the 2D architectural drawing manager; select a jurisdiction-specific code set from a multi-jurisdiction code database based on a project location; process the 2D architectural drawing and the jurisdiction-specific code set through a compliance machine learning algorithm which has been trained on a database of labeled training data associating 2D architectural drawings with jurisdiction-specific code compliance determinations, to generate a structured violation report identifying each code violation by violation type, applicable code section, location within the 2D architectural drawing, and one or more suggested corrections; generate an annotated 2D architectural drawing in which each identified violation is spatially marked at its location within the 2D architectural drawing; generate a corrected 2D architectural drawing based on the structured violation report; and re-submit the corrected 2D architectural drawing to the compliance machine learning algorithm and iterate until the corrected 2D architectural drawing satisfies all requirements of the jurisdiction-specific code set.

According to an aspect of an embodiment, the code compliance and correction module identifies conflicts between overlapping requirements of two or more building codes within the jurisdiction-specific code set and generates a conflict report for resolution prior to processing the 2D architectural drawing through the compliance machine learning algorithm.

According to an aspect of an embodiment, the structured violation report classifies each identified violation as critical or non-critical, and the code compliance and correction module iterates until all critical violations are resolved, with non-critical violations flagged for acceptance by a user.

According to an aspect of an embodiment, where the structured violation report identifies a violation requiring a design change, the code compliance and correction module transmits corrected structured requirements to a three-dimensional (3D) image generation manager for regeneration of the verified 3D architectural image and subsequent regeneration of the 2D architectural drawing.

According to an aspect of an embodiment, upon the corrected 2D architectural drawing satisfying all requirements of the jurisdiction-specific code set, the code compliance and correction module generates a compliance certification associated with the corrected 2D architectural drawing.

According to an aspect of an embodiment, the annotated 2D architectural drawing is presented to a user interface together with the structured violation report, and the code compliance and correction module receives user input comprising acceptance of one or more non-critical violations or a selection from among the one or more suggested corrections.

According to an aspect of an embodiment, the compliance machine learning algorithm is trained on a database of labeled training data comprising 2D architectural drawings annotated with identified building code violations, applicable code sections, and spatial locations of each violation within the drawings.

### BRIEF DESCRIPTION OF THE DRAWING FIGURES

FIG. 1 is a block diagram illustrating an exemplary system architecture for a platform for architectural drawing generation and review.

FIG. 2 is a block diagram illustrating an exemplary inputs and requirements analysis portal for a system for generating architectural drawings and images from text descriptions.

FIG. 3 is a block diagram illustrating exemplary architectural modeling engines for a system for generating architectural drawings and images from text descriptions.

FIG. 4 is a block diagram illustrating an exemplary 3D image generation manager for a system for generating architectural drawings and images from text descriptions.

FIG. 5 is a block diagram illustrating an exemplary 2D architectural drawing manager for a system for generating architectural drawings and images from text descriptions.

FIG. 6 is a flow diagram illustrating an exemplary process for generating architectural drawings and images from text descriptions.

FIG. 7 is a diagram illustrating an exemplary process for conversion of informal text to structural requirements.

FIG. 8 is a diagram illustrating an exemplary process for querying of architectural modeling engines.

FIG. 9 is a diagram illustrating an exemplary process for generation and verification of 3D architectural images.

FIG. 10 is a diagram illustrating an exemplary process for generation of 2D architectural images.

FIG. 11 is an exemplary screenshot for a structured question and answer manager.

FIG. 12 is a block diagram illustrating an exemplary code compliance and correction module for automated code compliance review and correction of 2D architectural drawings.

FIG. 13 is a block diagram illustrating an exemplary jurisdiction-aware code database structure with dynamic code set assembly and inter-code conflict detection for a code compliance and correction module.

FIG. 14 is a diagram illustrating an exemplary spatially annotated 2D architectural drawing output showing code violations identified by a code compliance and correction module, together with a structured violation report.

FIG. 15 is a block diagram illustrating an exemplary overall system architecture for a platform for architectural drawing generation and approval incorporating a code compliance and correction module.

FIG. 16 illustrates an exemplary computing environment on which an embodiment described herein may be implemented.

### DETAILED DESCRIPTION OF THE INVENTION

The inventor has conceived, and reduced to practice, a platform for architectural drawing generation and approval which allows for easy generation of 3D architectural images from text descriptions, question and answer templates, and/or sample images for user or designer review and approval, and conversion of those 3D architectural images to 2D architectural drawings for permitting and construction. In an embodiment, the system and method involve generating structured requirements via a question and answer structured template, generating 3D images from a combination of the structured requirements and sample images provided by a user, and generating 2D architectural drawings from the 3D architectural images. In an embodiment, the 2D architectural drawings can be submitted for automated code compliance checking via one or more architectural modeling engines.

One or more different aspects may be described in the present application. Further, for one or more of the aspects described herein, numerous alternative arrangements may be described; it should be appreciated that these are presented for illustrative purposes only and are not limiting of the aspects contained herein or the claims presented herein in any way. One or more of the arrangements may be widely applicable to numerous aspects, as may be readily apparent from the disclosure. In general, arrangements are described in sufficient detail to enable those skilled in the art to practice one or more of the aspects, and it should be appreciated that other arrangements may be utilized and that structural, logical, software, electrical and other changes may be made without departing from the scope of the particular aspects. Particular features of one or more of the aspects described herein may be described with reference to one or more particular aspects or figures that form a part of the present disclosure, and in which are shown, by way of illustration, specific arrangements of one or more of the aspects. It should be appreciated, however, that such features are not limited to usage in the one or more particular aspects or figures with reference to which they are described. The present disclosure is neither a literal description of all arrangements of one or more of the aspects nor a listing of features of one or more of the aspects that must be present in all arrangements.

Headings of sections provided in this patent application and the title of this patent application are for convenience only, and are not to be taken as limiting the disclosure in any way.

Devices that are in communication with each other need not be in continuous communication with each other, unless expressly specified otherwise. In addition, devices that are in communication with each other may communicate directly or indirectly through one or more communication means or intermediaries, logical or physical.

A description of an aspect with several components in communication with each other does not imply that all such components are required. To the contrary, a variety of optional components may be described to illustrate a wide variety of possible aspects and in order to more fully illustrate one or more aspects. Similarly, although process steps, method steps, algorithms or the like may be described in a sequential order, such processes, methods and algorithms may generally be configured to work in alternate orders, unless specifically stated to the contrary. In other words, any sequence or order of steps that may be described in this patent application does not, in and of itself, indicate a requirement that the steps be performed in that order. The steps of described processes may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to one or more of the aspects, and does not imply that the illustrated process is preferred. Also, steps are generally described once per aspect, but this does not mean they must occur once, or that they may only occur once each time a process, method, or algorithm is carried out or executed. Some steps may be omitted in some aspects or some occurrences, or some steps may be executed more than once in a given aspect or occurrence.

When a single device or article is described herein, it will be readily apparent that more than one device or article may be used in place of a single device or article. Similarly, where more than one device or article is described herein, it will be readily apparent that a single device or article may be used in place of the more than one device or article.

The functionality or the features of a device may be alternatively embodied by one or more other devices that are not explicitly described as having such functionality or features. Thus, other aspects need not include the device itself.

Techniques and mechanisms described or referenced herein will sometimes be described in singular form for clarity. However, it should be appreciated that particular aspects may include multiple iterations of a technique or multiple instantiations of a mechanism unless noted otherwise. Process descriptions or blocks in figures should be understood as representing modules, segments, or portions of code which include one or more executable instructions for implementing specific logical functions or steps in the process. Alternate implementations are included within the scope of various aspects in which, for example, functions may be executed out of order from that shown or discussed, including substantially concurrently or in reverse order, depending on the functionality involved, as would be understood by those having ordinary skill in the art.

### Detailed Descriptions of the Drawings

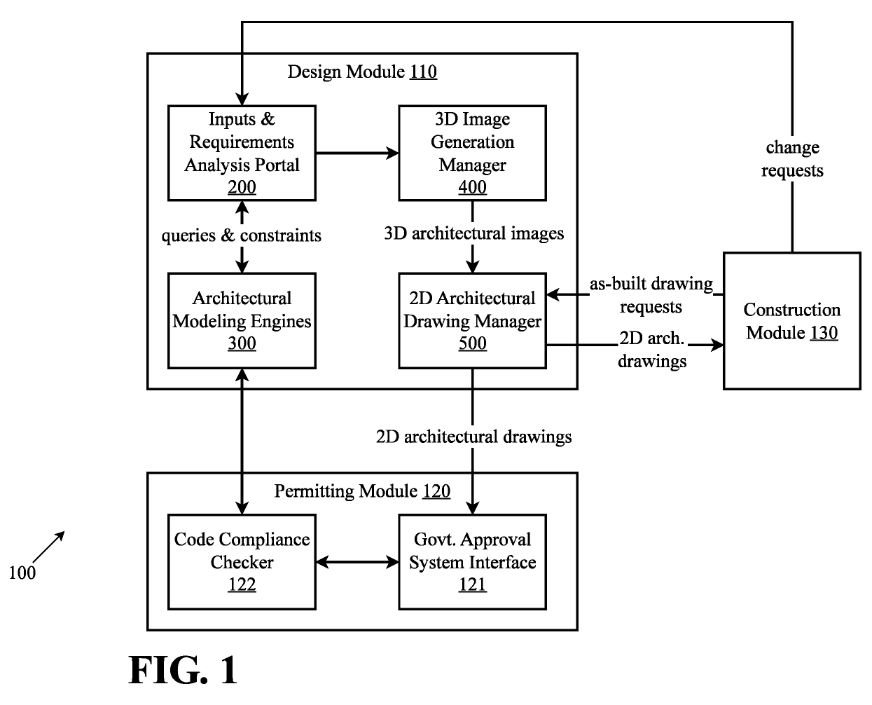

FIG. 1 is a block diagram illustrating an exemplary system architecture 100 for a system for generating architectural drawings and images from text descriptions. The system of this example comprises a design module 110, a permitting module 120, and a construction module 130.

Design module 110 comprises an inputs and requirements analysis portal 200, one or more architectural modeling engines 300, a 3D image generation manager 400, and a 2D architectural drawing manager 500.

Inputs and requirements analysis portal 200 receives some combination of an informal text description of an architectural design, a set of structured requirements developed via a structured question and answer (Q&A) manager, and sample images showing designs, colors, and textures liked by a user. As an example of informal text input, a user may simply enter: “Design me a kitchen/dining room combination separated by a breakfast counter.” Inputs and requirements analysis portal 200 parses the text to create structured requirements, queries one or more architectural modeling engines 300 for compatibility with the models, receives constraints or conflicts from the modeling engines, and prompts the user for missing information or resolution of identified constraints or conflicts. In addition to, or in substitution or, the informal text, a user may enter structured requirements for the design directly into a structured Q&A manager. The user may also provide sample images showing designs, colors, and textures that the user prefers, which may be incorporated at the 3D image generation stage. Once the querying and prompting process is complete, updated structured requirements are sent to 3D image generation manager 400 for generation of architectural images, and to 2D architectural drawing manager 500 for generation of architectural drawings.

Architectural modeling engines 300 are specialized models which determine whether certain characteristics of an intended design will comply with certain sets of rules, standards, measurements, or tolerances. Each architectural modeling engine will have one or more parameters or sets of parameters for determining compliance of elements in a design and/or for selecting appropriate sizes and components for the elements in a design. Each element of the structured requirements of a design is compared to the modeling engine applicable to that element to see whether the element falls within the parameters of the modeling engine. Some modeling engines may have multiple sets of parameters (e.g., an appliance database may have different parameters for each brand of refrigerators). Where an element falls within an applicable set of parameters contained in a modeling engine, the modeling engine may return a confirmation of compliance. Where an element falls outside of an applicable set of parameters contained in a modeling engine, the modeling engine may return a rejection or error. The rejection or error may comprise information such as notification of the rejection or error; the type of rejection or error; constraints such as size mismatches, configuration mismatches, connector mismatches, power requirement mismatches, and potential building code violations; and suggestions for compliance such as size changes, configuration recommendations, suggested adaptors for connection mismatches, and recommendations for bringing the element in compliance with building codes. Some modeling engines may be used for selection of, or recommendation of, components that comply with a given element of a design. For example, if a design specifies a “large refrigerator” a modeling engine may recommend several brands and/or sizes of refrigerator that meet that description. Modeling engines may be used in conjunction with one another. For example, if a design specifies a “large refrigerator” and “standard height wall-mounted cabinets,” a fitting engine may retrieve and recommend a standard wall-mounted cabinet height for a given industry (e.g., residential homes) and may pass that standard height to an appliance selection engine for selection of a “large” refrigerator that fits underneath that standard height, excluding models that fall outside of that requirement.

3D image generation manager 400 receives the informal text, structured requirements, and/or sample images from inputs and requirements analysis portal 200, and converts the informal text (if necessary) into a formal text description using an AI-based architectural text generator. 3D image generation manager 400 generates a 3D architectural image of the intended design from some combination of the formal text description, structured requirements, and the sample images using an AI-based image generation engine, verifies the accuracy, consistency, suitability, and/or usefulness of the image for purposes of the design using one or more verification methods, makes appropriate corrections based on the verifications, and outputs a final 3D architectural image for conversion to 2D architectural drawings.

2D architectural drawing manager 500 receives the 3D architectural images and generates 2D architectural drawings for the intended architectural design. The 2D architectural drawings may be used for visualization, measurement, construction bids, permit applications, and/or other purposes for which such drawings are typically used. In an embodiment, the 2D architectural drawings are output to a permitting module 120, and a construction module 130

Permitting module 120 allows for automated or assisted government approval of the 2D architectural drawings, and process which is currently done manually and takes weeks or months to complete. The 2D architectural drawings are received at a government approval system interface 121 which engages a code compliance checker 122 to process the 2D architectural drawings through one or more architectural modeling engines 300 to verify compliance with building code requirements and to check for design errors such an non-fitting components.

Construction module 130 allows contractors to receive electronic copies of the 2D architectural drawings for construction. Where changes occur during construction, the contractor may submit change requests which may be sent to inputs & requirements analysis portal 200 for redo or correction of the design. Logs may be kept of the changes during construction. Upon completion of construction the contractor may request a copy of the as-built drawings, showing the actual construction including changes.

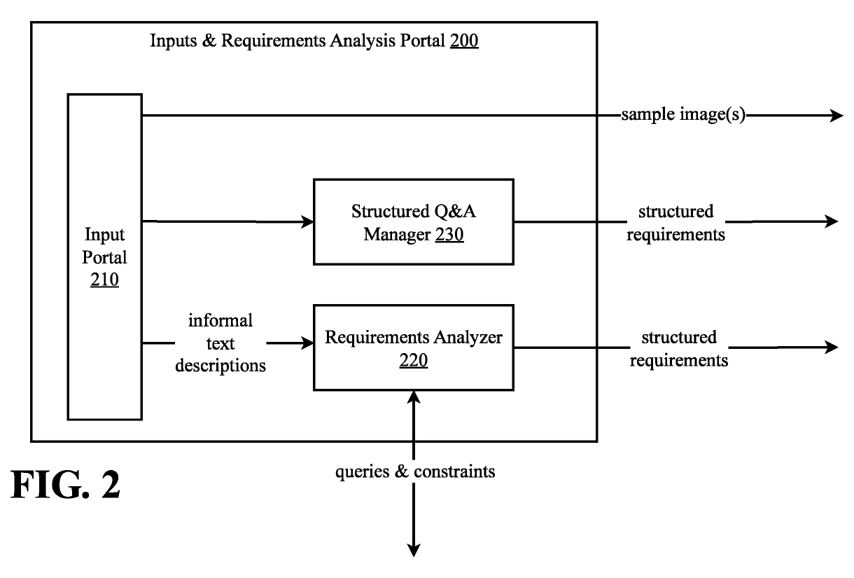

FIG. 2 is a block diagram illustrating an exemplary inputs and requirements analysis portal for a system for generating architectural drawings and images from text descriptions, structured requirements, and/or sample images. Inputs and requirements analysis portal 200 receives some combination of an informal text description of an architectural design, a set of structured requirements developed via a structured question and answer (Q&A) manager, and sample images showing designs, colors, and textures liked by a user via an input portal 210.

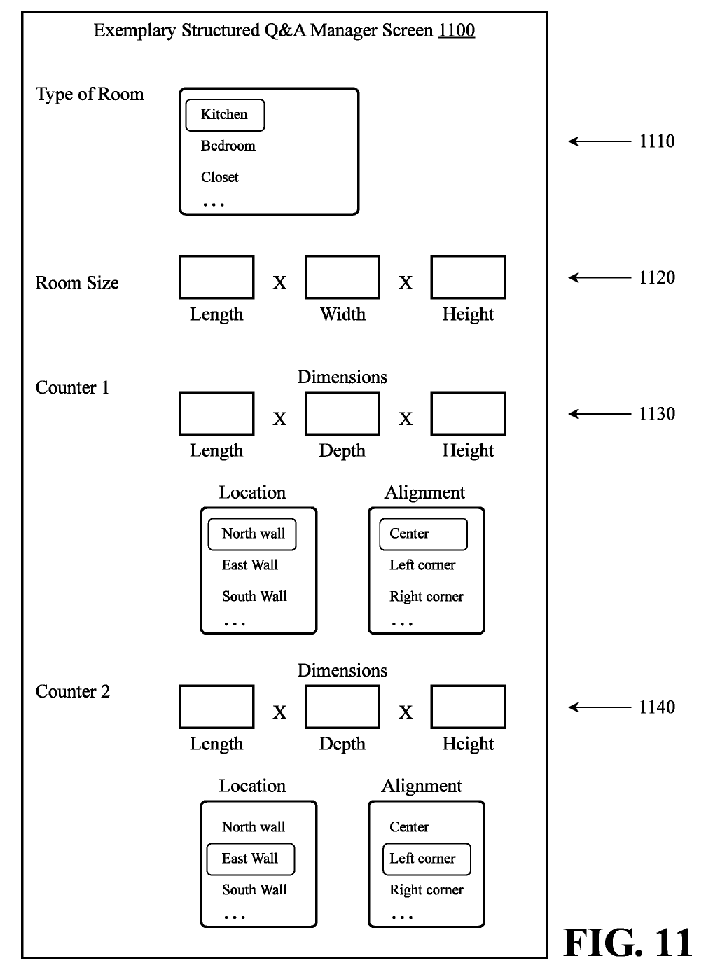

Samples images are passed directly to 3D image generation manager.

Where no informal text description is provided, user may enter structured requirements directly into a structured Q&A manager 230. One way to obtain structured requirements for a design project is to query the user using a structured question and answer (Q&A) design template. A structured Q&A design template allows for inputs from a user in a structured format which reduces error and uncertainty and can be directly placed into any needed structured requirements format. An exemplary screenshot for a structured Q&A manager is shown in FIG. 11.

An example of an informal text description might be: “Design me a kitchen/dining room combination separated by a breakfast counter.” Input portal 210 passes the information text description to a requirements analyzer 220, which parses the text into its constituent parts of speech and identifies elements of architectural design. Requirements analyzer 220 may use a natural language processing (NLP) engine (not shown) to recognize the words and phrases and place them in context in order to organize them into structured requirements. Requirements analyzer 220 creates an initial set of structured requirements for the design from the identified elements in the parsed text, and uses the structured requirements to query architectural modeling engines 300 for compliance with model parameters for each element of the design and/or for selection of any appropriate components. Requirements analyzer 220 receives selections, constraints, and/or conflicts from the modeling engines, and prompts the user for missing information or resolution of identified constraints or conflicts. Once the querying and prompting process is complete, Requirements analyzer 220 generates updated structured requirements and sends them to 3D image generation manager 400 for generation of architectural images, and to 2D architectural drawing manager 500 for generation of architectural drawings.

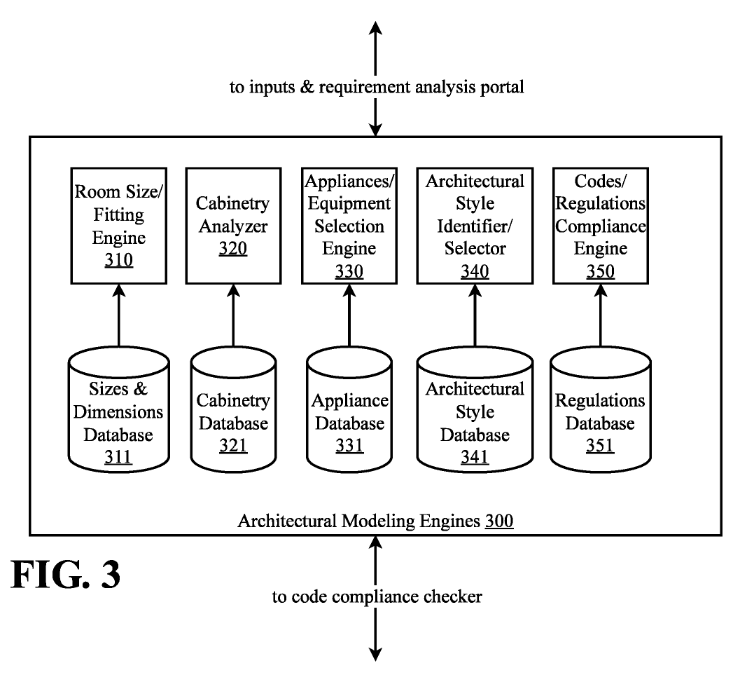

FIG. 3 is a block diagram illustrating exemplary architectural modeling engines for a system for generating architectural drawings and images from text descriptions. A room size/fitting engine 310 may be used to determine whether the room dimensions will fit within the intended overall design, such as determining whether a room height fits within the allocated space between floors of a building, and whether certain elements will fit within available spaces, such as determining whether a particular brand of refrigerator will fit within a space allocated for it, or trying various options for locating cabinetry selected by a cabinetry engine and recommending or placing the cabinetry in the design. Parameters for room size/fitting engine 310 may be stored in a sizes and dimensions database 311, which may comprise industry standard architectural sizes, standards, and/or materials, or architectural sizes, standards, and/or materials for particular clients, projects, circumstances, or applications.

A cabinetry analyzer 320 may be used to select or recommend cabinetry dimensions, countertop heights, cabinet and drawer dimensions, and construction materials. Parameters for cabinetry analyzer 320 may be stored in a cabinetry database 321, which may comprise industry standard architectural sizes, standards, and/or materials, or architectural sizes, standards, and/or materials for particular clients, projects, circumstances, or applications.

An appliances/equipment selection engine 330 may be used to select or recommend appliances and/or equipment appropriate for elements of a design, taking into consideration the specifications of the appliances and/or equipment such as sizes, power requirements, connectors, construction materials, finishes and exterior appearances, and manufacturer recommendations. Parameters for appliances/equipment selection engine 330 may be stored in an appliances/equipment database 331, which may comprise industry standard architectural sizes, standards, and/or materials, or architectural sizes, standards, and/or materials for particular clients, projects, circumstances, or applications.

An architectural style identifier/selector 340 may be used to identify an architectural design that will be compatible with the intended overall design or to select architectural elements consistent with an identified or specified architectural style, such as form, space, light, materials, textures, colors, and scale; ceiling heights, types, and designs; arches, columns, and other structural elements; engravings, carvings, and other artistic elements; straight lines and curves; and patterns, finishes, visual details, and textural details. Parameters for architectural style identifier/selector 340 may be stored in an architectural style database 341, which may comprise industry standard architectural sizes, standards, and/or materials, or architectural sizes, standards, and/or materials for particular clients, projects, circumstances, or applications.

A building code and regulations compliance engine 350 may be used to determine whether elements of the design comply with applicable building codes and regulations such as setback and sizing requirements, weight bearing requirements, safety requirements, materials requirements, electrical requirements, and sewage and plumbing requirements. Parameters for building code and regulations compliance engine 350 may be stored in a regulations database 351, which may comprise industry standard architectural sizes, standards, and/or materials, or architectural sizes, standards, and/or materials for particular clients, projects, circumstances, or applications.

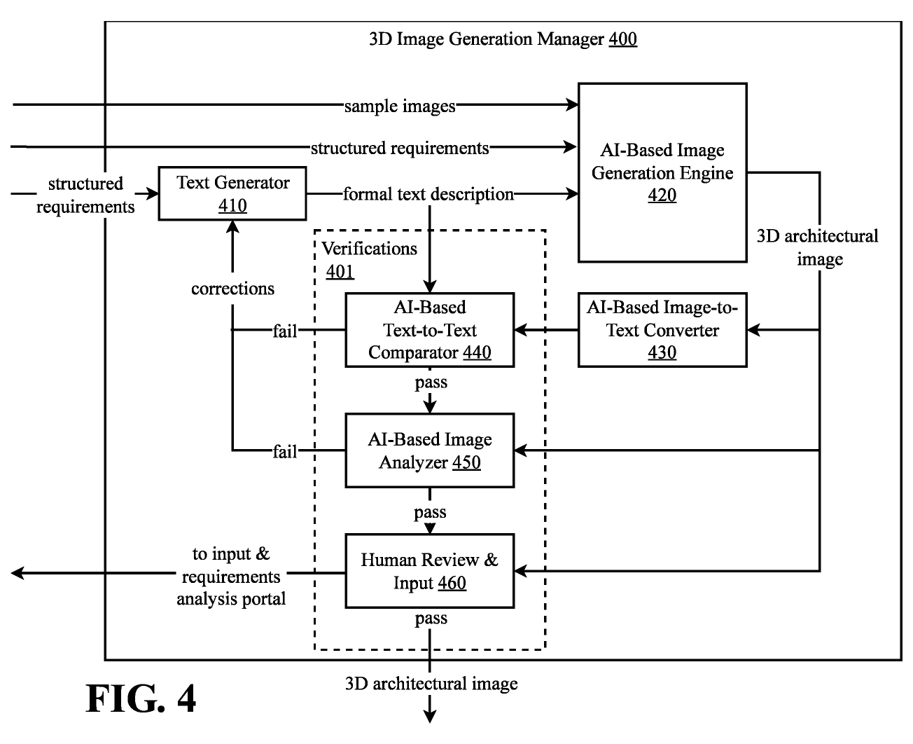

FIG. 4 is a block diagram illustrating an exemplary 3D image generation manager for a system for generating architectural drawings and images from some combination of text descriptions, structured requirements, and sample images. 3D image generation manager 400 receives sample images and structured requirements from inputs and requirements analysis portal 200. Where AI-based image generation engine 420 has been trained to generate images from text, the structured requirements are first received at an AI-based architectural text generator 410. AI-based architectural text generator 410 comprises a machine learning algorithm configured to convert structural requirements in some form of a data structure (e.g., tables, database formats like SQL databases, JSON files, etc.) into a formal text description which describes the design in terms of its constituent elements and their relationship to one another. In this embodiment, AI-based architectural text generator 410 comprises a purpose-built supervised machine learning algorithm which is trained by processing large amounts of labeled architectural training data through machine learning algorithm so that it develops its own, internal, weighted connections for identifying design elements in the structured requirements and associating architectural words and phrases with those elements. In other embodiments, different types of machine learning algorithms may be used, including those trained using training data that is not specialized to the purpose of recognizing architectural terms. The formal text description is then passed to AI-based image generation engine 420 which generates a 3D architectural image from the formal text description, optionally in conjunction with the structured requirements and/or sample images. In this configuration, AI-based image generation engine 420 comprises an open-source or third-party machine learning algorithm trained to produce images from text by an unknown process. A number of such AI-based image generation engines have been developed in recent years such as DALL*E 2, Midjourney, DreamStudio, and others. None of these image generation engines is trained specifically for generating architectural images, so their outputs will be generic and may not be suitable for architectural design purposes. However, an advantage of the system architecture described herein is that an open-source or third-party image generator may be used in this application because its outputs (which will likely not be tailored to architectural applications) will be modified, amended, and updated through a verification process using one or more verification methods. In other embodiments, AI-based architectural text generator 410 will comprise a purpose-built supervised machine learning algorithm which is trained by processing large amounts of labeled training data through machine learning algorithm so that it develops its own, internal, weighted connections for identifying design elements and associating text with those elements.

Where AI-based image generation engine 420 has been trained to generate images from a combination of structured requirements and sample images, AI-based image generation engine 420 is trained to receive the structured requirements, generate a blank size template (e.g., room dimensions with blank walls) and to apply texturing, special room configurations, or other design elements as shown in the sample images. For example, if the sample images show a kitchen in a Tuscany-style design, coloring and texturing may be applied to the black walls of the template in light earth tones with trowel marks indicating manual application of wall plaster (as opposed to the flat texture of machine-made drywall). AI-based image generation engine 420 may be trained to generate 3D architectural images from a database of labeled training data associating structured requirements with their 3D architectural image counterparts and associating colors, textures, and other design features from sample images with components of 3D architectural images.

Each image generated is then subjected to one or more verification methods 401, a non-limiting list of which includes text-image comparison, image analysis, and human review and input. For the first of these methods, an AI-based image-to-text converter 430 performs the reverse operation of AI-based image generation engine 420, converting the image to a text description. The resulting text description is passed to an AI-based text-to-text comparator 440 to determine the extent to which the text description matches the formal text description used to generate the image. To ensure accuracy of the comparison, AI-based text-to-text comparator 440 of this embodiment comprises a purpose-built supervised machine learning algorithm which is trained by processing large amounts of labeled training data through machine learning algorithm so that it develops its own, internal, weighted connections for identifying design elements and associating text with those elements. A threshold for matching of the text description and formal text description may be established whereby comparison meeting or exceeding the threshold results in a pass of that particular verification. A fail will result in generation of a list of discrepancies between the two text descriptions which will be passed back to AI-based architectural text generator for re-generation of the formal text description to refine it based on discrepancies. In some embodiments, the discrepancies will be passed back further to requirements analyzer 220 to update the structural requirements which will then be re-sent to 3D image generation manager 400.

For the second of these methods, an AI-based image analyzer 450 analyzes the image to determine whether it appears to be an image that reflects the subject of the formal text description. AI-based image analyzer 450 of this embodiment is an open-source or third-party machine learning algorithm trained to identify the subject of an image. A number of such AI-based subject identification engines have been developed in recent years such as Clarifai, Locobuzz, Amazon™ rekognition, Google™ vision AI, various plant recognition engines, and others. None of these image generation engines is trained specifically for generating architectural images, but many will be able to recognize distinct features such as “this is an image of a kitchen,” which is sufficient for confirmation that the generated architectural image is in the right category of things. A threshold for matching of the image analysis output and formal text description may be established whereby comparison meeting or exceeding the threshold results in a pass of that particular verification. A fail will result in generation of a list of discrepancies between the image analysis output and the formal text description which will be passed back to AI-based architectural text generator for re-generation of the formal text description to refine it based on discrepancies. In some embodiments, the discrepancies will be passed back further to requirements analyzer 220 to update the structural requirements which will then be re-sent to 3D image generation manager 400.

For the third of these methods, human review and input 460 will be used to assess the degree to which the generated image meets the user’s mental concept of the intended design and suitability of the generated image for the user’s purposes. In this method, the user determines whether the generated image passes or fails as a representation of the intended design, and the user may provide text feedback comprising discrepancies between the image and the user’s mental concept of the intended design. The user’s indication of a fail will cause any discrepancies noted by the user to be passed back to input & requirements analysis portal for re-generation or correction of the structured requirements and/or for input of different or additional sample images.

After the generated image passes all verification steps, a final 3D image is output and passed to 2D architectural drawing manager.

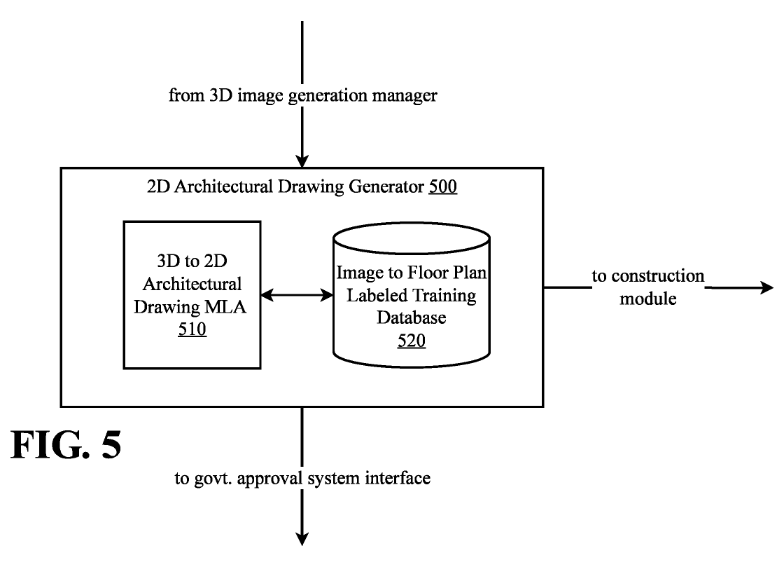

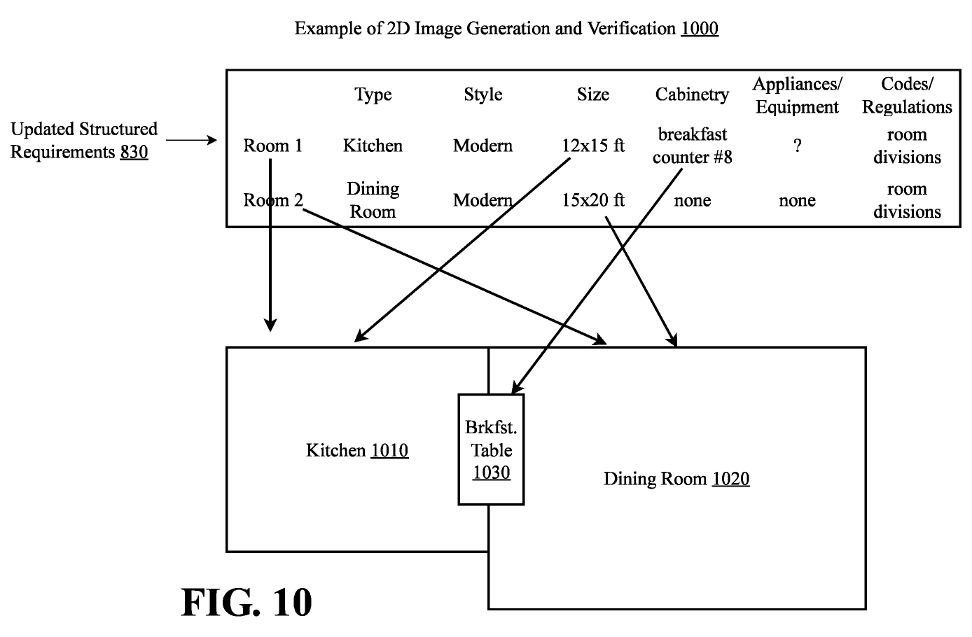

FIG. 5 is a block diagram illustrating an exemplary 2D architectural drawing manager for a system for generating architectural drawings and images from text descriptions. 2D architectural drawing manager 500 receives the 3D image(s) and generates 2D architectural drawings for the intended architectural design. 2D architectural drawing manager 500 comprises a 3D to 2D architectural drawing machine learning algorithm(MLA) 510 which performs the conversion. 3D to 2D architectural drawing MLA 510 is trained to convert 3D architectural images to 2D architectural drawings using a database of labeled training data associating 3D architectural images with their floor plans 520. In some embodiments, 3D to 2D architectural drawing MLA 510 may further be trained to utilize the structured requirements in making the conversion. In some embodiments, tools other than an MLA may be used to convert the structured requirements directly to 2D architectural drawings as described in the process shown in FIG. 10. Where conflicts or ambiguities exist, they can be clarified by querying architectural modeling engines 300 or by prompting the user for additional information. The 2D architectural drawings may be used for visualization, measurement, construction bids, permit applications, and/or other purposes for which such drawings are typically used.

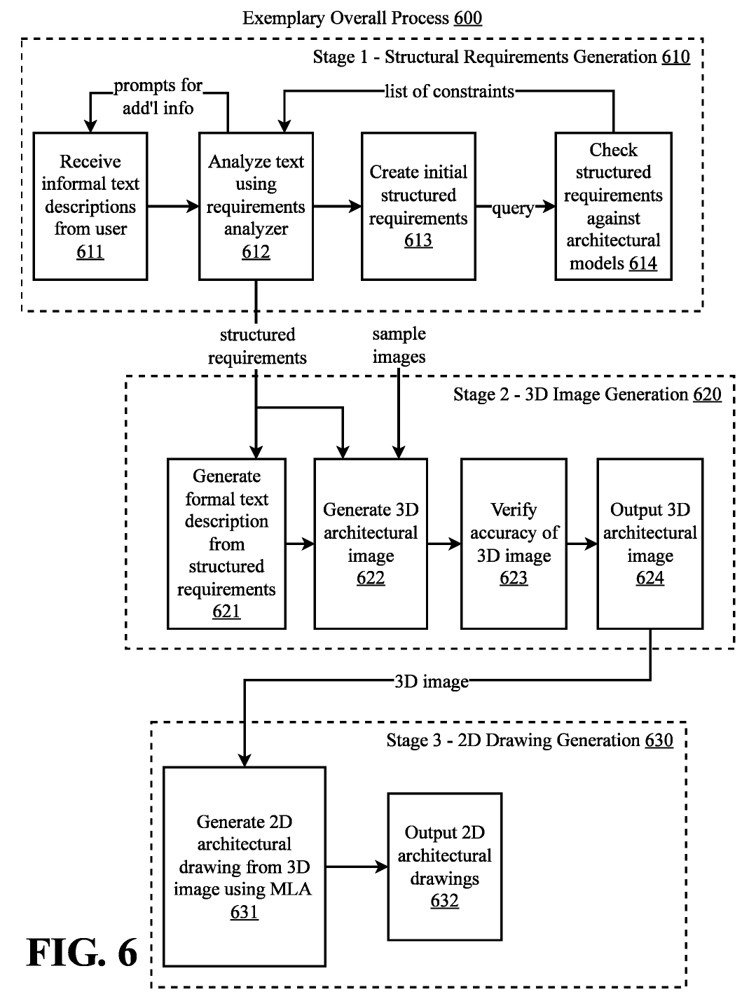

FIG. 6 is a flow diagram illustrating an exemplary process for generating architectural drawings and images from text descriptions. The exemplary overall process 600 can be divided into roughly three stages, a structural requirements generation stage 610, a 3D image generation stage 620, and a 2D architectural drawings stage 630. In this embodiment, the latter two stages 620, 630 can be performed in parallel as they both depend on receipt of structured requirements for their operation.

If, at the structural requirements generation stage 610, an informal text description of an architectural design concept is received 611, for example: “Design me a kitchen/dining room combination separated by a breakfast counter,” the text is analyzed at step 612 and any missing information is gathered either by prompting the user for additional information. When step 612 is complete, a set of initial structured requirements is generated at step 613. The structured requirements are checked by querying one or more architectural models 300 for compatibility with the models 614. When structural requirements generation stage 610 is complete, updated structured requirements are sent to 3D image generation manager 400 for generation of architectural images, and to 2D architectural drawing manager 500 for generation of architectural drawings.

At 3D image generation stage 620, structured requirements are received and converted into a formal text description using an AI-based architectural text generator at step 621. The structured requirements may be received from the process described at step 610, or directly from a structured Q&A manager of inputs and requirements analysis portal 200 as described in FIG. 11. Sample images may also be received from inputs and requirements analysis portal 200. A 3D architectural image is generated from the structured requirements and/or sample images using an AI-based image generation engine at step 622. At step 623, the accuracy, consistency, suitability, and/or usefulness of the image for purposes of the design is verified using one or more verification methods, and appropriate corrections are made based on the verifications. When the verifications are passed, final 3D architectural images are output at step 633 to 2D architectural drawings stage 630.

At 2D architectural drawings stage 630, the 3D image(s) are received and a 3D to 2D architectural drawing machine learning algorithm(MLA) 510 converts the 3D images to 2D architectural drawings. 3D to 2D architectural drawing MLA 510 is trained to convert 3D architectural images to 2D architectural drawings using a database of labeled training data associating 3D architectural images with their floor plans 520. In some embodiments, 3D to 2D architectural drawing MLA 510 may further be trained to utilize the structured requirements in making the conversion. In some embodiments, tools other than an MLA may be used to convert the structured requirements directly to 2D architectural drawings as described in the process shown in FIG. 10.

In summary, this process allows users to generate architectural drawings and images quickly and easily from an informal text description without the need for specialized training or experience.

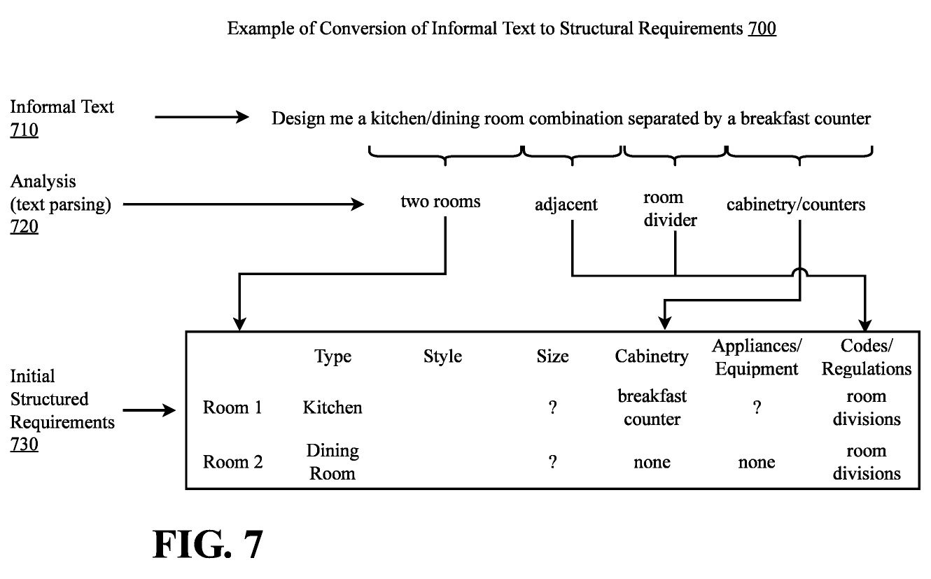

FIG. 7 is a diagram illustrating an exemplary process for conversion of informal text to structural requirements. In this exemplary process 700, an informal text description of an architectural design concept is received at step 710, in this case the exemplary text being: “Design me a kitchen/dining room combination separated by a breakfast counter.” At step 720, the text is parsed into its constituent words and phrases and analyzed to determine the meaning or intent of each word or phrase, and at step 730 the meaning or intent is stored in a set of initial structured requirements. The parsing and recognition of words and phrases may be performed by a natural language processing (NLP) engine (not shown) trained to recognize the words and phrases and place them in context in order to organize them into structured requirements. For example, the phrase “a kitchen/dining room,” when logically analyzed, indicates that two rooms must exist, which is stored in the initial structured requirements data structure as “Room 1” and “Room 2.” The phrase “combination,” when logically analyzed, indicates that the two rooms are adjacent to one another, and the phrase “separated by” indicates that the adjacent rooms have a room divider, which both cause storage in the initial structured requirements data structure of a “room divisions” flag for checking applicable building code architectural models. The phrase “a breakfast counter” indicates that there is some cabinetry, which is stored in the initial structured requirements data structure as “breakfast counter” (which may be associated with Room 1 – Kitchen by querying an architectural model).

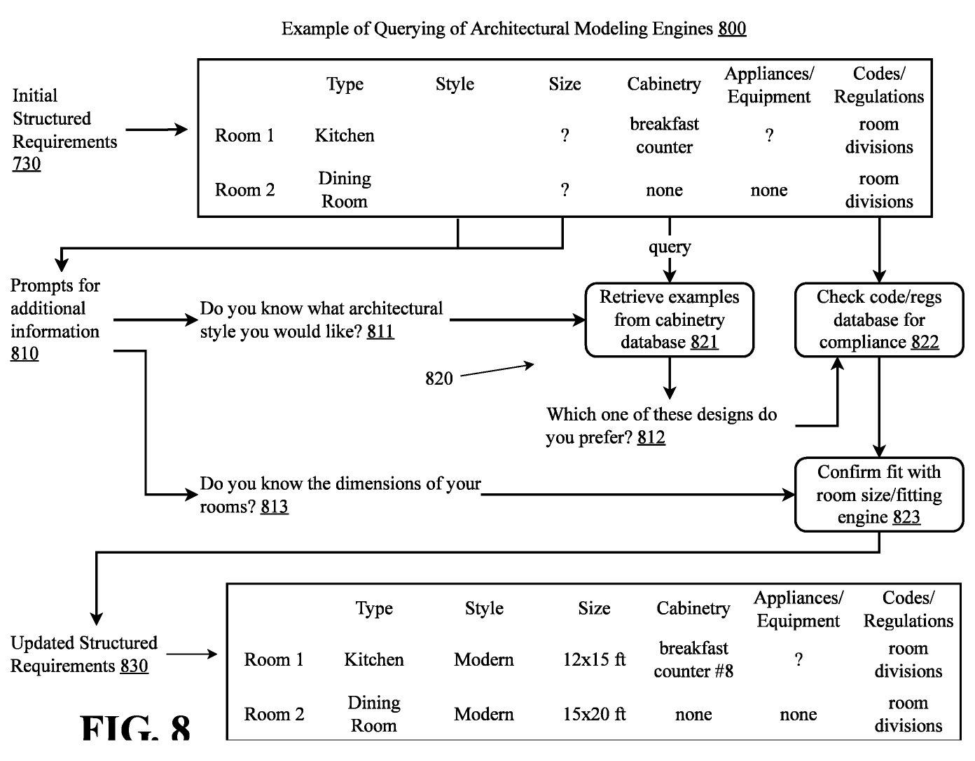

FIG. 8 is a diagram illustrating an exemplary process for querying of architectural modeling engines. In this exemplary process 800, the initial structured requirements data structure of step 730 is received, which contains missing size information as indicated by the question marks. At step 810, prompts for additional information are made to fill in missing information and to obtain additional information by querying architectural models.

A first query 811 asks the user: “Do you know what architectural style you would like?” to which the user responds: “Modern.” This information is incorporated into an updated structured requirements data structure at step 830.

A series of queries to architectural models 820 is made to clarify ambiguities or provide additional information. At step 821, the type of breakfast counter is unknown, so a query is made to a cabinetry database to retrieve a breakfast counter in the “Modern” style requested by the user. At step 812, a second query asked the user to select one of several offered breakfast counter designs retrieved from the cabinetry database. At step 822, the user’s selection is queried against a building code architectural model to confirm compliance with building codes. At step 813, the user is asked to provide the dimensions of the room, and at step 823, the user’s selection of the breakfast counter is checked against a fitting/sizing architectural model to ensure that it fits in the room or in the location selected.

Finally, at step 830, the missing information, clarifications, and resolution of ambiguities are incorporated into an updated structured requirements data structure.

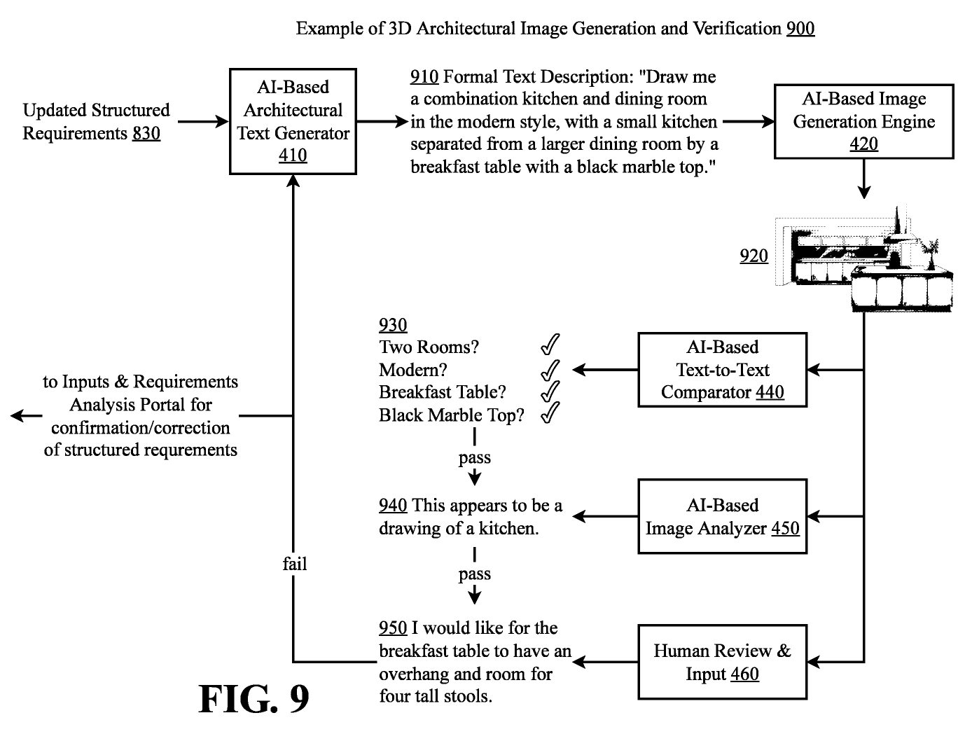

FIG. 9 is a diagram illustrating an exemplary process for generation and verification of 3D architectural images. The updated structural requirements of step 830 are received at AI-based architectural text generator 410. AI-based architectural text generator 410 comprises a machine learning algorithm configured to convert structural requirements in some form of a data structure (e.g., tables, database formats like SQL databases, JSON files, etc.) into a formal text description 910 which describes the design in terms of its constituent elements and their relationship to one another. In this example, the formal text description of step 910 is “Draw me a combination kitchen and dining room in the modern style, with a small kitchen separated from a larger dining room by a breakfast table with a black marble top.” In this embodiment, AI-based architectural text generator 410 comprises a purpose-built supervised machine learning algorithm which is trained by processing large amounts of labeled architectural training data through machine learning algorithm so that it develops its own, internal, weighted connections for identifying design elements in the structured requirements and associating architectural words and phrases with those elements. In other embodiments, different types of machine learning algorithms may be used, including those trained using training data that is not specialized to the purpose of recognizing architectural terms.

The formal text description of step 910 is then passed to AI-based image generation engine 420 which generates a 3D architectural image 920 from the formal text description. In this embodiment, AI-based image generation engine 420 comprises an open-source or third-party machine learning algorithm trained to produce images from text by an unknown process. A number of such AI-based image generation engines have been developed in recent years such as DALL*E 2, Midjourney, DreamStudio, and others. None of these image generation engines is trained specifically for generating architectural images, so their outputs will be generic and may not be suitable for architectural design purposes. However, an advantage of the system architecture described herein is that an open-source or third-party image generator may be used in this application because its outputs (which will likely not be tailored to architectural applications) will be modified, amended, and updated through a verification process using one or more verification methods. In other embodiments, AI-based architectural text generator 410 will comprise a purpose-built supervised machine learning algorithm which is trained by processing large amounts of labeled training data through machine learning algorithm so that it develops its own, internal, weighted connections for identifying design elements and associating text with those elements.

Each image generated is then subjected to one or more verification methods, a non-limiting list of which includes text-image comparison 930, image analysis 940, and human review and input 950. For the first of these methods, an AI-based image-to-text converter 430 performs the reverse operation of AI-based image generation engine 420, converting the image to a text description. The resulting text description is passed to an AI-based text-to-text comparator 440 to determine the extent to which the text description matches the formal text description used to generate the image. Here, the text to text comparison 930 indicates that all of the expected elements of the design (two rooms, modern style, breakfast table, and black marble top) are met by the design, such that this image passes this verification step 930.

To ensure accuracy of the comparison, AI-based text-to-text comparator 440 of this embodiment comprises a purpose-built supervised machine learning algorithm which is trained by processing large amounts of labeled training data through machine learning algorithm so that it develops its own, internal, weighted connections for identifying design elements and associating text with those elements. A threshold for matching of the text description and formal text description may be established whereby comparison meeting or exceeding the threshold results in a pass of that particular verification. A fail will result in generation of a list of discrepancies between the two text descriptions which will be passed back to AI-based architectural text generator for re-generation of the formal text description to refine it based on discrepancies. In some embodiments, the discrepancies will be passed back further to requirements analyzer 220 to update the structural requirements which will then be re-sent to 3D image generation manager 400.

For the second of these methods, an AI-based image analyzer 450 analyzes the image to determine whether it appears to be an image that reflects the subject of the formal text description. Here, the image analysis indicates that this appears to be a drawing of a kitchen 940, which verifies the subject matter of the image, thus passing this verification step 940.

AI-based image analyzer 450 of this embodiment is an open-source or third-party machine learning algorithm trained to identify the subject of an image. A number of such AI-based subject identification engines have been developed in recent years such as Clarifai, Locobuzz, Amazon™ rekognition, Google™ vision AI, various plant recognition engines, and others. None of these image generation engines is trained specifically for generating architectural images, but many will be able to recognize distinct features such as “this is an image of a kitchen,” which is sufficient for confirmation that the generated architectural image is in the right category of things. A threshold for matching of the image analysis output and formal text description may be established whereby comparison meeting or exceeding the threshold results in a pass of that particular verification. A fail will result in generation of a list of discrepancies between the image analysis output and the formal text description which will be passed back to AI-based architectural text generator for re-generation of the formal text description to refine it based on discrepancies. In some embodiments, the discrepancies will be passed back further to requirements analyzer 220 to update the structural requirements which will then be re-sent to 3D image generation manager 400.

For the third of these methods, human review and input 460 will be used to assess the degree to which the generated image meets the user’s mental concept of the intended design and suitability of the generated image for the user’s purposes. In this method, the user determines whether the generated image passes or fails as a representation of the intended design, and the user may provide text feedback comprising discrepancies between the image and the user’s mental concept of the intended design. The user’s indication of a fail will cause any discrepancies noted by the user to be passed back to AI-based architectural text generator for re-generation of the formal text description to refine it based on discrepancies. In some embodiments, the discrepancies will be passed back further to requirements analyzer 220 to update the structural requirements which will then be re-sent to 3D image generation manager 400. Here, the user has indicated that he would like for the breakfast table to have an overhang and room for four tall stools. Thus, the image fails the human review and input verification 460 at step 950, and the user’s input is sent either back to AI-based architectural text generator 410 for re-generation of the formal text description and/or back to inputs and requirements analysis portal 200 for confirmation and/or correction of the structured requirements.

After the generated image passes all verification steps, a final 3D image is output. Depending on configuration, the final 3D image and the formal text description may be passed on to 2D architectural drawing manager.

FIG. 10 is a diagram illustrating an exemplary process for generation of 2D architectural images. 2D architectural drawing manager 500 receives structured requirements for the intended design, and generates 2D architectural drawings for the intended architectural design. As the structured requirements are in the form of a data structure, they can be readily converted to 2D architectural drawings by mapping of the data fields in the data structure to drawing elements. In this example, Room 1 is shown in the structured requirements as a kitchen of size 12ft x 15ft, which is converted to a kitchen 1010 of the indicated size in a 2D architectural drawing. Room 2 is shown in the structured requirements as a dining room of size 15ft x 20ft, which is converted to a dining room 1020 in the 2D architectural drawing. Breakfast counter #8 is shown in the structured requirements as a room divider and is converted to a breakfast table 1030 of the indicated size in the 2D architectural drawing.

Where conflicts or ambiguities exist, they can be clarified by querying architectural modeling engines 300 or by prompting the user for additional information. A floor plan rendering tool 520 may be used to display the resulting 2D architectural drawings. The 2D architectural drawings may be used for visualization, measurement, construction bids, permit applications, and/or other purposes for which such drawings are typically used.

FIG. 11 is an exemplary screenshot for a structured question and answer manager. One way to obtain structured requirements for a design project is to query the user using a structured question and answer (Q&A) design template. A structured Q&A design template allows for inputs from a user in a structured format which reduces error and uncertainty and can be directly placed into any needed structured requirements format.

Here, an exemplary screenshot 1100 for a structured question and answer manager is shown. The screenshot 1100 is divided into several sections, one for the type of room being designed 1110, one for the size of the room 1120, one for a first counter 1130, and one for a second counter 1140.

The type of room section 1110 has a drop down menu which allows a user to select the type of room being designed. Here, a dropdown menu is shown with options for kitchen, bedroom, closet, and ellipses showing that addition options are available. The type of room “kitchen” is shown as being selected in the dropdown menu.

The room size section 1120 shows discrete data entry boxes for the room dimensions, length, width, and height. Using discrete data entry boxes minimizes error and uncertainty.

Because the room type is “kitchen,” options for counters are displayed to the user. In the counter 1 section 1130, discrete data entry boxes for the counter dimensions, length, width, and height. Using discrete data entry boxes minimizes error and uncertainty. A dropdown menu is shown for the location of the counter with options for north wall, east wall, south wall, and ellipses showing that addition options are available. The location “north wall” is shown as being selected in the dropdown menu. A dropdown menu is shown for the alignment of the counter with options for center, left corner, right corner, and ellipses showing that addition options are available. The location “center” is shown as being selected in the dropdown menu. In the counter 2 section 1140, discrete data entry boxes for the counter dimensions, length, width, and height. Using discrete data entry boxes minimizes error and uncertainty. A dropdown menu is shown for the location of the counter with options for north wall, east wall, south wall, and ellipses showing that addition options are available. The location “east wall” is shown as being selected in the dropdown menu. A dropdown menu is shown for the alignment of the counter with options for center, left corner, right corner, and ellipses showing that addition options are available. The location “left corner” is shown as being selected in the dropdown menu.

The structured Q&A format of this example can be expanded to any type of room, size of room, shape of room, and cabinets and furnishings for each room.

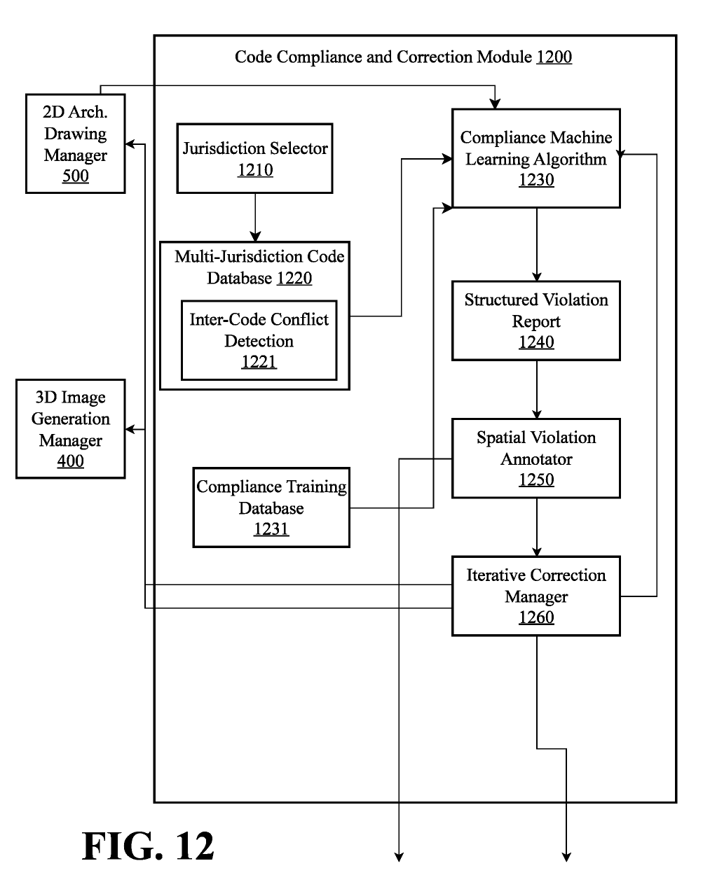

FIG. 12 is a block diagram illustrating an exemplary code compliance and correction module 1200 for automated code compliance review and correction of 2D architectural drawings. Code compliance and correction module 1200 is an expansion of permitting module 120, and operates on the output 2D architectural drawings generated by 2D architectural drawing manager 500. Whereas building code and regulations compliance engine 350 operates on structured requirements at the input stage of the design process, before generation of 3D architectural images and 2D architectural drawings, code compliance and correction module 1200 operates at the output stage of the design process, receiving the finalized 2D architectural drawing itself as its primary input. This distinction allows code compliance and correction module 1200 to detect compliance failures that cannot be detected from structured requirements alone, such as egress path geometry, required room area calculations derived from actual drawing dimensions, and setback measurements, which exist only in the geometry of the completed 2D architectural drawings.

Code compliance and correction module 1200 receives as inputs the output 2D architectural drawing from 2D architectural drawing manager 500, the structured requirements for the design, and a project location. The 2D architectural drawing is used for spatial compliance analysis, while the structured requirements may be used for cross-referencing the design intent against detected violations, for example to determine whether a detected violation arises from a drafting error or from an element of the intended design. The project location comprises, at a minimum, a state and a municipality, and may further comprise a county, a street address, a parcel identifier, or other location information.

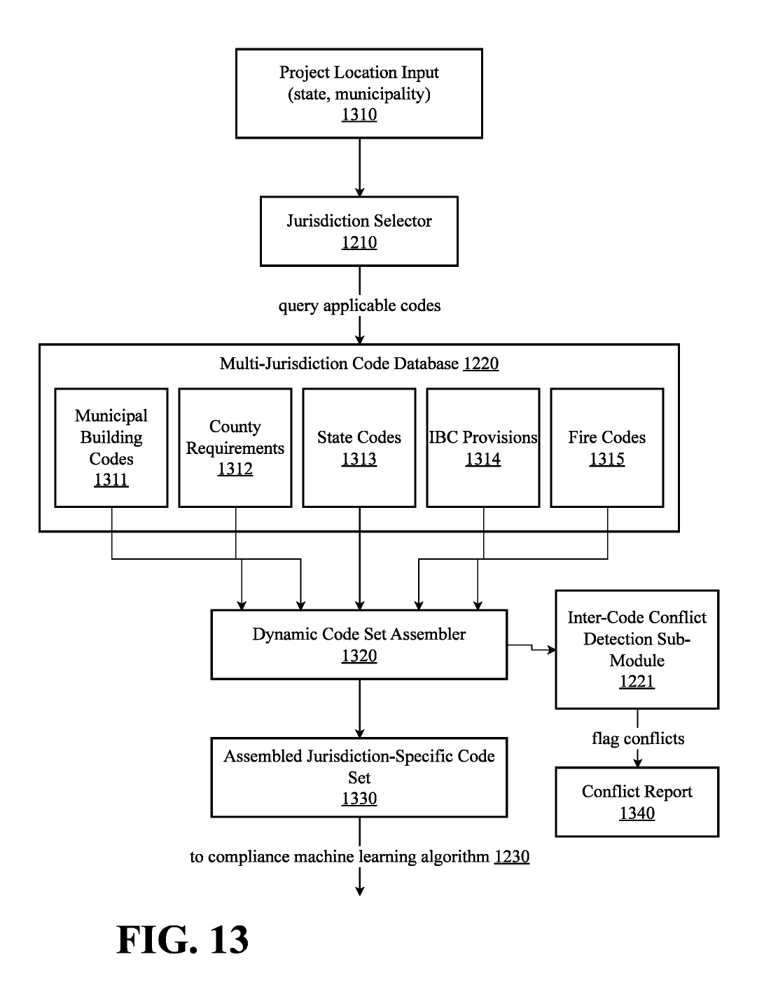

The project location is received at a jurisdiction selector 1210, which queries a multi-jurisdiction code database 1220 and dynamically assembles the set of codes applicable to the project location, which may comprise municipal building codes, county requirements, state codes, applicable International Building Code (IBC) provisions, and fire codes. Where overlapping requirements exist between two or more codes of the assembled code set, an inter-code conflict detection sub-module 1221 identifies and flags the conflicts for resolution. The assembled jurisdiction-specific code set is passed to a compliance machine learning algorithm 1230. The structure and operation of multi-jurisdiction code database 1220 and the assembly of the jurisdiction-specific code set are described in further detail below with reference to FIG. 13.

Compliance machine learning algorithm 1230 receives the 2D architectural drawing and the assembled jurisdiction-specific code set, and analyzes the 2D architectural drawing for compliance with each requirement of the jurisdiction-specific code set. Compliance machine learning algorithm 1230 of this embodiment comprises a purpose-built supervised machine learning algorithm which is trained by processing large amounts of labeled training data from a compliance training database 1231 through the machine learning algorithm so that it develops its own, internal, weighted connections associating features of 2D architectural drawings with jurisdiction-specific code compliance determinations. The labeled training data of compliance training database 1231 comprises 2D architectural drawings annotated with identified building code violations, the applicable code sections, and the spatial locations of each violation within the drawings. In other embodiments, different types of machine learning algorithms may be used.

Compliance machine learning algorithm 1230 produces a structured violation report 1240 comprising, for each identified violation: a violation type identifier; the applicable code section; the location of the violation within the 2D architectural drawing, expressed as drawing coordinates or as a region of the drawing; a severity classification; and one or more suggested corrections. If no violations are identified, code compliance and correction module 1200 outputs a compliance certification associated with the 2D architectural drawing, and the 2D architectural drawing proceeds to government approval system interface 121 and/or to construction module 130.

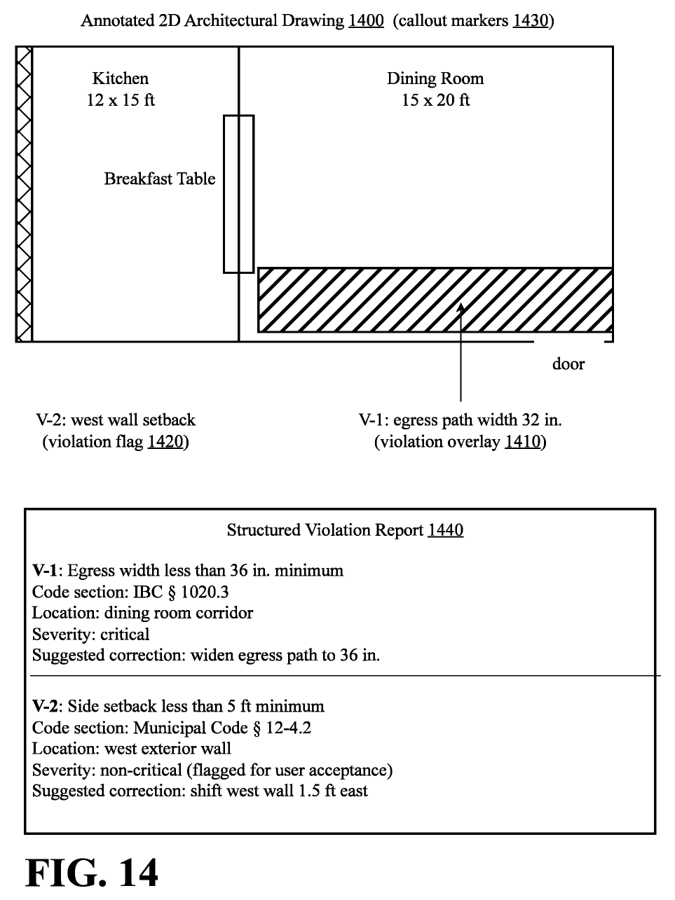

A spatial violation annotator 1250 receives structured violation report 1240 and the 2D architectural drawing, and generates an annotated 2D architectural drawing in which each identified violation is visually marked at its spatial location within the drawing, for example using highlighted regions or callout markers linked to the violation identifiers of structured violation report 1240. The annotated 2D architectural drawing and structured violation report 1240 are presented to the user and/or returned to 2D architectural drawing manager 500 for correction. An example of an annotated 2D architectural drawing is described below with reference to FIG. 14.

An iterative correction manager 1260 generates a corrected 2D architectural drawing based on structured violation report 1240. Corrections to the 2D architectural drawing may be generated automatically by compliance machine learning algorithm 1230, for example by applying one or more of the suggested corrections of structured violation report 1240, or may be generated through updated structured requirements re-entered into inputs and requirements analysis portal 200. The corrected 2D architectural drawing is re-submitted to compliance machine learning algorithm 1230, and this loop continues until the 2D architectural drawing passes all applicable requirements of the jurisdiction-specific code set or the user accepts a 2D architectural drawing with outstanding non-critical violations.

Where a compliance failure requires changes to the underlying design, as opposed to drafting corrections only, code compliance and correction module 1200 propagates the corrections upstream to 3D image generation manager 400 for regeneration of the 3D architectural image, followed by re-generation of the 2D architectural drawing by 2D architectural drawing manager 500, thus closing the full pipeline loop from compliance analysis back through image generation and drawing generation. Upon the 2D architectural drawing passing all applicable requirements of the jurisdiction-specific code set, code compliance and correction module 1200 outputs a compliance-certified 2D architectural drawing suitable for permit application and construction.

FIG. 13 is a block diagram illustrating an exemplary jurisdiction-aware code database structure 1300 for a code compliance and correction module. A project location input 1310 is received from the user, comprising at a minimum a state and a municipality. The project location is received at jurisdiction selector 1210, which queries multi-jurisdiction code database 1220 for the building codes and regulations applicable to the project location. Multi-jurisdiction code database 1220 may comprise a plurality of code stores, such as municipal building codes 1311, county requirements 1312, state codes 1313, International Building Code (IBC) provisions 1314, and fire codes 1315, and may further comprise other codes and regulations such as energy codes, plumbing codes, electrical codes, and accessibility requirements.

A dynamic code set assembler 1320 retrieves the applicable requirements from each code store identified by jurisdiction selector 1210 and assembles them into an assembled jurisdiction-specific code set 1330. Because the requirements of two or more codes may overlap or conflict for a given project location, for example where a municipal code and a state code impose different minimum requirements for the same element of a design, inter-code conflict detection sub-module 1221 compares the requirements of the assembled code set and generates a conflict report 1340 identifying any conflicts for resolution prior to compliance analysis. Resolution of an identified conflict may be performed automatically, for example by applying the more stringent of two conflicting requirements, or by prompting the user or a code official for a resolution.

Assembled jurisdiction-specific code set 1330 is passed to compliance machine learning algorithm 1230 for compliance analysis of the 2D architectural drawing as described above with reference to FIG. 12.

FIG. 14 is a diagram illustrating an exemplary spatially annotated 2D architectural drawing output 1400 showing code violations identified by a code compliance and correction module, together with a structured violation report. Continuing the example of FIG. 10, the 2D architectural drawing comprises a kitchen of size 12 ft x 15 ft and a dining room of size 15 ft x 20 ft, separated by a breakfast table. Here, compliance machine learning algorithm 1230 has analyzed the 2D architectural drawing against an assembled jurisdiction-specific code set and has identified two violations, which are spatially marked within annotated 2D architectural drawing 1400 by callout markers 1430.

The first violation, marked V-1, indicates that the egress path through the dining room has a width of 32 inches, which is less than the minimum egress width required by the applicable code section of the jurisdiction-specific code set. A violation overlay 1410 visually marks the spatial location of the egress path violation within the drawing. The second violation, marked V-2, indicates that the west exterior wall of the kitchen does not satisfy an applicable side setback requirement. A violation flag 1420 visually marks the spatial location of the setback violation within the drawing. Note that neither of these violations could have been detected from the structured requirements alone, as each arises from the geometry of the completed 2D architectural drawing.

A structured violation report 1440 is presented to the user together with annotated 2D architectural drawing 1400, and lists, for each identified violation: a violation type identifier; the applicable code section; the location of the violation within the drawing, expressed as drawing coordinates or as a region of the drawing; a severity classification; and one or more suggested corrections. Here, violation V-1 is classified as critical, and must be resolved before a compliance certification will issue, while violation V-2 is classified as non-critical and is flagged for acceptance by the user. The user may accept violation V-2, may select one of the suggested corrections, or may enter updated structured requirements into inputs and requirements analysis portal 200, in which case the corrections are propagated through regeneration of the design as described above with reference to FIG. 12.

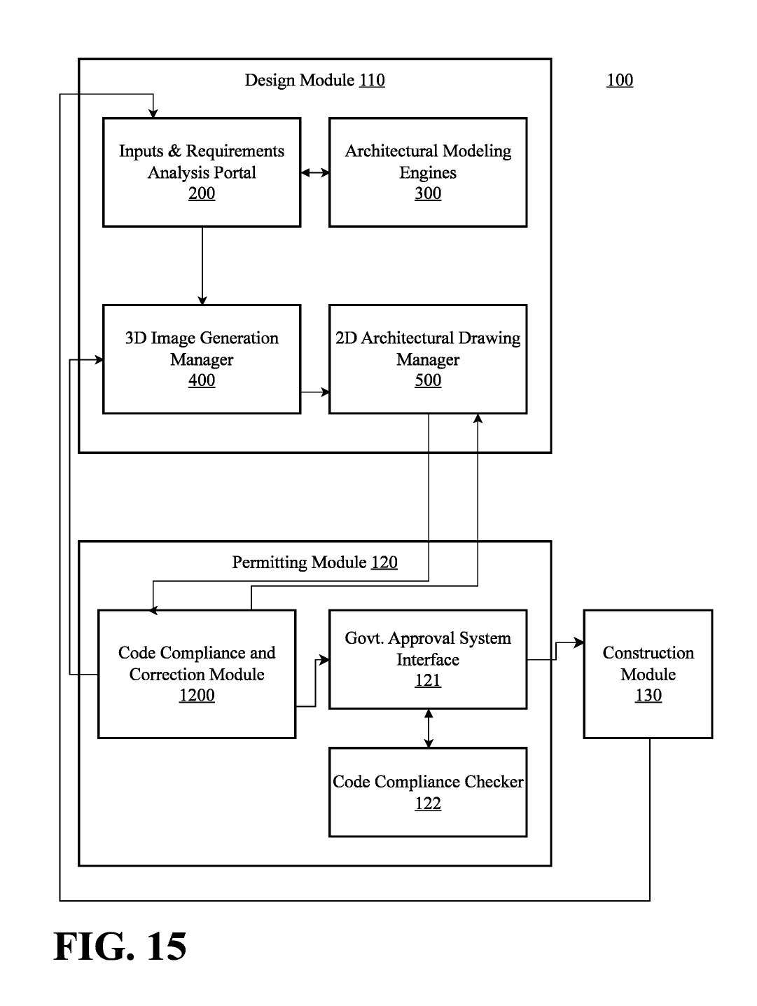

FIG. 15 is a block diagram illustrating an exemplary updated overall system architecture 100 for a platform for architectural drawing generation and approval incorporating a code compliance and correction module. The system of this example comprises a design module 110, a permitting module 120, and a construction module 130, each as described above with reference to FIG. 1, with permitting module 120 expanded to comprise code compliance and correction module 1200 in addition to government approval system interface 121 and code compliance checker 122.

The 2D architectural drawings output by 2D architectural drawing manager 500 are received at code compliance and correction module 1200 for compliance analysis as described above with reference to FIG. 12. Drafting corrections are returned by code compliance and correction module 1200 to 2D architectural drawing manager 500 for correction and re-generation of the 2D architectural drawings, while corrections requiring design changes are propagated upstream to 3D image generation manager 400 for regeneration of the 3D architectural image and subsequent re-generation of the 2D architectural drawings. Compliance-certified 2D architectural drawings are passed to government approval system interface 121 for submission to the applicable government approval authority, and to construction module 130 for construction.

### Exemplary Computing Environment

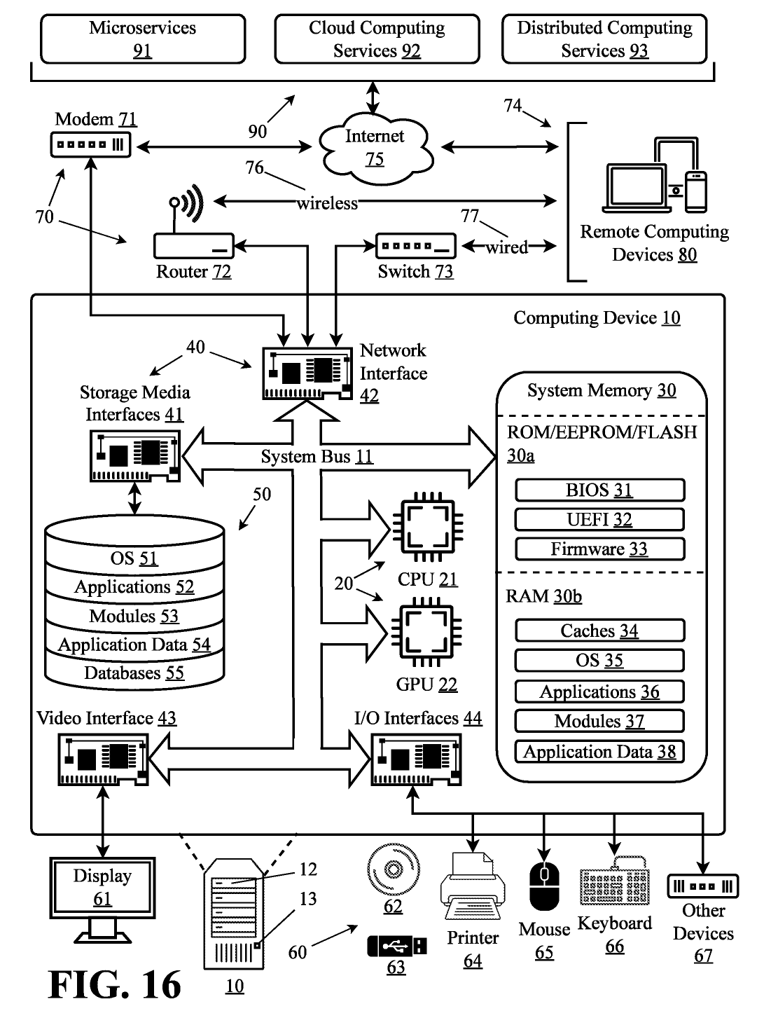

FIG. 16 illustrates an exemplary computing environment on which an embodiment described herein may be implemented, in full or in part. This exemplary computing environment describes computer-related components and processes supporting enabling disclosure of computer-implemented embodiments. Inclusion in this exemplary computing environment of well-known processes and computer components, if any, is not a suggestion or admission that any embodiment is no more than an aggregation of such processes or components. Rather, implementation of an embodiment using processes and components described in this exemplary computing environment will involve programming or configuration of such processes and components resulting in a machine specially programmed or configured for such implementation. The exemplary computing environment described herein is only one example of such an environment and other configurations of the components and processes are possible, including other relationships between and among components, and/or absence of some processes or components described. Further, the exemplary computing environment described herein is not intended to suggest any limitation as to the scope of use or functionality of any embodiment implemented, in whole or in part, on components or processes described herein.

The exemplary computing environment described herein comprises a computing device 10 (further comprising a system bus 11, one or more processors 20, a system memory 30, one or more interfaces 40, one or more non-volatile data storage devices 50), external peripherals and accessories 60, external communication devices 70, remote computing devices 80, and cloud-based services 90.

System bus 11 couples the various system components, coordinating operation of and data transmission between those various system components. System bus 11 represents one or more of any type or combination of types of wired or wireless bus structures including, but not limited to, memory busses or memory controllers, point-to-point connections, switching fabrics, peripheral busses, accelerated graphics ports, and local busses using any of a variety of bus architectures. By way of example, such architectures include, but are not limited to, Industry Standard Architecture (ISA) busses, Micro Channel Architecture (MCA) busses, Enhanced ISA (EISA) busses, Video Electronics Standards Association (VESA) local busses, a Peripheral Component Interconnects (PCI) busses also known as a Mezzanine busses, or any selection of, or combination of, such busses. Depending on the specific physical implementation, one or more of the processors 20, system memory 30 and other components of the computing device 10 can be physically co-located or integrated into a single physical component, such as on a single chip. In such a case, some or all of system bus 11 can be electrical pathways within a single chip structure.

Computing device may further comprise externally-accessible data input and storage devices 12 such as compact disc read-only memory (CD-ROM) drives, digital versatile discs (DVD), or other optical disc storage for reading and/or writing optical discs 62; magnetic cassettes, magnetic tape, magnetic disk storage, or other magnetic storage devices; or any other medium which can be used to store the desired content and which can be accessed by the computing device 10. Computing device may further comprise externally-accessible data ports or connections 12 such as serial ports, parallel ports, universal serial bus (USB) ports, and infrared ports and/or transmitter/receivers. Computing device may further comprise hardware for wireless communication with external devices such as IEEE 1394 (“Firewire”) interfaces, IEEE 802.11 wireless interfaces, BLUETOOTH® wireless interfaces, and so forth. Such ports and interfaces may be used to connect any number of external peripherals and accessories 60 such as visual displays, monitors, and touch-sensitive screens 61, USB solid state memory data storage drives (commonly known as “flash drives” or “thumb drives”) 63, printers 64, pointers and manipulators such as mice 65, keyboards 66, and other devices 67 such as joysticks and gaming pads, touchpads, additional displays and monitors, and external hard drives (whether solid state or disc-based), microphones, speakers, cameras, and optical scanners.

Processors 20 are logic circuitry capable of receiving programming instructions and processing (or executing) those instructions to perform computer operations such as retrieving data, storing data, and performing mathematical calculations. Processors 20 are not limited by the materials from which they are formed or the processing mechanisms employed therein, but are typically comprised of semiconductor materials into which many transistors are formed together into logic gates on a chip (i.e., an integrated circuit or IC). The term processor includes any device capable of receiving and processing instructions including, but not limited to, processors operating on the basis of quantum computing, optical computing, mechanical computing (e.g., using nanotechnology entities to transfer data), and so forth. Depending on configuration, computing device 10 may comprise more than one processor. For example, computing device 10 may comprise one or more central processing units (CPUs) 21, each of which itself has multiple processors or multiple processing cores, each capable of independently or semi-independently processing programming instructions based on technologies like complex instruction set computer (CISC) or reduced instruction set computer (RISC). Further, computing device 10 may comprise one or more specialized processors such as a graphics processing unit (GPU) 22 configured to accelerate processing of computer graphics and images via a large array of specialized processing cores arranged in parallel. Further computing device 10 may be comprised of one or more specialized processes such as Intelligent Processing Units, field-programmable gate arrays or application-specific integrated circuits for specific tasks or types of tasks. The term processor may further include: neural processing units (NPUs) or neural computing units optimized for machine learning and artificial intelligence workloads using specialized architectures and data paths; tensor processing units (TPUs) designed to efficiently perform matrix multiplication and convolution operations used heavily in neural networks and deep learning applications; application-specific integrated circuits (ASICs) implementing custom logic for domain-specific tasks; application-specific instruction set processors (ASIPs) with instruction sets tailored for particular applications; field-programmable gate arrays (FPGAs) providing reconfigurable logic fabric that can be customized for specific processing tasks; processors operating on emerging computing paradigms such as quantum computing, optical computing, mechanical computing (e.g., using nanotechnology entities to transfer data), and so forth. Depending on configuration, computing device 10 may comprise one or more of any of the above types of processors in order to efficiently handle a variety of general purpose and specialized computing tasks. The specific processor configuration may be selected based on performance, power, cost, or other design constraints relevant to the intended application of computing device 10.

System memory 30 is processor-accessible data storage in the form of volatile and/or nonvolatile memory. System memory 30 may be either or both of two types: non-volatile memory and volatile memory. Non-volatile memory 30a is not erased when power to the memory is removed, and includes memory types such as read only memory (ROM), electronically-erasable programmable memory (EEPROM), and rewritable solid state memory (commonly known as “flash memory”). Non-volatile memory 30a is typically used for long-term storage of a basic input/output system (BIOS) 31, containing the basic instructions, typically loaded during computer startup, for transfer of information between components within computing device, or a unified extensible firmware interface (UEFI), which is a modern replacement for BIOS that supports larger hard drives, faster boot times, more security features, and provides native support for graphics and mouse cursors. Non-volatile memory 30a may also be used to store firmware comprising a complete operating system 35 and applications 36 for operating computer-controlled devices. The firmware approach is often used for purpose-specific computer-controlled devices such as appliances and Internet-of-Things (IoT) devices where processing power and data storage space is limited. Volatile memory 30b is erased when power to the memory is removed and is typically used for short-term storage of data for processing. Volatile memory 30b includes memory types such as random-access memory (RAM), and is normally the primary operating memory into which the operating system 35, applications 36, program modules 37, and application data 38 are loaded for execution by processors 20. Volatile memory 30b is generally faster than non-volatile memory 30a due to its electrical characteristics and is directly accessible to processors 20 for processing of instructions and data storage and retrieval. Volatile memory 30b may comprise one or more smaller cache memories which operate at a higher clock speed and are typically placed on the same IC as the processors to improve performance.

There are several types of computer memory, each with its own characteristics and use cases. System memory 30 may be configured in one or more of the several types described herein, including high bandwidth memory (HBM) and advanced packaging technologies like chip-on-wafer-on-substrate (CoWoS). Static random access memory (SRAM) provides fast, low-latency memory used for cache memory in processors, but is more expensive and consumes more power compared to dynamic random access memory (DRAM). SRAM retains data as long as power is supplied. DRAM is the main memory in most computer systems and is slower than SRAM but cheaper and more dense. DRAM requires periodic refresh to retain data. NAND flash is a type of non-volatile memory used for storage in solid state drives (SSDs) and mobile devices and provides high density and lower cost per bit compared to DRAM with the trade-off of slower write speeds and limited write endurance. HBM is an emerging memory technology that provides high bandwidth and low power consumption which stacks multiple DRAM dies vertically, connected by through-silicon vias (TSVs). HBM offers much higher bandwidth (up to 1 TB/s) compared to traditional DRAM and may be used in high-performance graphics cards, AI accelerators, and edge computing devices. Advanced packaging and CoWoS are technologies that enable the integration of multiple chips or dies into a single package. CoWoS is a 2.5D packaging technology that interconnects multiple dies side-by-side on a silicon interposer and allows for higher bandwidth, lower latency, and reduced power consumption compared to traditional PCB-based packaging. This technology enables the integration of heterogeneous dies (e.g., CPU, GPU, HBM) in a single package and may be used in high-performance computing, AI accelerators, and edge computing devices.

Interfaces 40 may include, but are not limited to, storage media interfaces 41, network interfaces 42, display interfaces 43, and input/output interfaces 44. Storage media interface 41 provides the necessary hardware interface for loading data from non-volatile data storage devices 50 into system memory 30 and storage data from system memory 30 to non-volatile data storage device 50. Network interface 42 provides the necessary hardware interface for computing device 10 to communicate with remote computing devices 80 and cloud-based services 90 via one or more external communication devices 70. Display interface 43 allows for connection of displays 61, monitors, touchscreens, and other visual input/output devices. Display interface 43 may include a graphics card for processing graphics-intensive calculations and for handling demanding display requirements. Typically, a graphics card includes a graphics processing unit (GPU) and video RAM (VRAM) to accelerate display of graphics. In some high-performance computing systems, multiple GPUs may be connected using NVLink bridges, which provide high-bandwidth, low-latency interconnects between GPUs. NVLink bridges enable faster data transfer between GPUs, allowing for more efficient parallel processing and improved performance in applications such as machine learning, scientific simulations, and graphics rendering. One or more input/output (I/O) interfaces 44 provide the necessary support for communications between computing device 10 and any external peripherals and accessories 60. For wireless communications, the necessary radio-frequency hardware and firmware may be connected to I/O interface 44 or may be integrated into I/O interface 44. Network interface 42 may support various communication standards and protocols, such as Ethernet and Small Form-Factor Pluggable (SFP). Ethernet is a widely used wired networking technology that enables local area network (LAN) communication. Ethernet interfaces typically use RJ45 connectors and support data rates ranging from 10 Mbps to 100 Gbps, with common speeds being 100 Mbps, 1 Gbps, 10 Gbps, 25 Gbps, 40 Gbps, and 100 Gbps. Ethernet is known for its reliability, low latency, and cost-effectiveness, making it a popular choice for home, office, and data center networks. SFP is a compact, hot-pluggable transceiver used for both telecommunication and data communications applications. SFP interfaces provide a modular and flexible solution for connecting network devices, such as switches and routers, to fiber optic or copper networking cables. SFP transceivers support various data rates, ranging from 100 Mbps to 100 Gbps, and can be easily replaced or upgraded without the need to replace the entire network interface card. This modularity allows for network scalability and adaptability to different network requirements and fiber types, such as single-mode or multi-mode fiber.

Non-volatile data storage devices 50 are typically used for long-term storage of data. Data on non-volatile data storage devices 50 is not erased when power to the non-volatile data storage devices 50 is removed. Non-volatile data storage devices 50 may be implemented using any technology for non-volatile storage of content including, but not limited to, CD-ROM drives, digital versatile discs (DVD), or other optical disc storage; magnetic cassettes, magnetic tape, magnetic disc storage, or other magnetic storage devices; solid state memory technologies such as EEPROM or flash memory; or other memory technology or any other medium which can be used to store data without requiring power to retain the data after it is written. Non-volatile data storage devices 50 may be non-removable from computing device 10 as in the case of internal hard drives, removable from computing device 10 as in the case of external USB hard drives, or a combination thereof, but computing device will typically comprise one or more internal, non-removable hard drives using either magnetic disc or solid state memory technology. Non-volatile data storage devices 50 may be implemented using various technologies, including hard disk drives (HDDs) and solid-state drives (SSDs). HDDs use spinning magnetic platters and read/write heads to store and retrieve data, while SSDs use NAND flash memory. SSDs offer faster read/write speeds, lower latency, and better durability due to the lack of moving parts, while HDDs typically provide higher storage capacities and lower cost per gigabyte. NAND flash memory comes in different types, such as Single-Level Cell (SLC), Multi-Level Cell (MLC), Triple-Level Cell (TLC), and Quad-Level Cell (QLC), each with trade-offs between performance, endurance, and cost. Storage devices connect to the computing device 10 through various interfaces, such as SATA, NVMe, and PCIe. SATA is the traditional interface for HDDs and SATA SSDs, while NVMe (Non-Volatile Memory Express) is a newer, high-performance protocol designed for SSDs connected via PCIe. PCIe SSDs offer the highest performance due to the direct connection to the PCIe bus, bypassing the limitations of the SATA interface. Other storage form factors include M.2 SSDs, which are compact storage devices that connect directly to the motherboard using the M.2 slot, supporting both SATA and NVMe interfaces. Additionally, technologies like Intel Optane memory combine 3D XPoint technology with NAND flash to provide high-performance storage and caching solutions. Non-volatile data storage devices 50 may be non-removable from computing device 10, as in the case of internal hard drives, removable from computing device 10, as in the case of external USB hard drives, or a combination thereof. However, computing devices will typically comprise one or more internal, non-removable hard drives using either magnetic disc or solid-state memory technology. Non-volatile data storage devices 50 may store any type of data including, but not limited to, an operating system 51 for providing low-level and mid-level functionality of computing device 10, applications 52 for providing high-level functionality of computing device 10, program modules 53 such as containerized programs or applications, or other modular content or modular programming, application data 54, and databases 55 such as relational databases, non-relational databases, object oriented databases, NoSQL databases, vector databases, knowledge graph databases, key-value databases, document oriented data stores, and graph databases.

Applications (also known as computer software or software applications) are sets of programming instructions designed to perform specific tasks or provide specific functionality on a computer or other computing devices. Applications are typically written in high-level programming languages such as C, C++, Scala, Erlang, GoLang, Java, Scala, Rust, and Python, which are then either interpreted at runtime or compiled into low-level, binary, processor-executable instructions operable on processors 20. Applications may be containerized so that they can be run on any computer hardware running any known operating system. Containerization of computer software is a method of packaging and deploying applications along with their operating system dependencies into self-contained, isolated units known as containers. Containers provide a lightweight and consistent runtime environment that allows applications to run reliably across different computing environments, such as development, testing, and production systems facilitated by specifications such as containerd.

The memories and non-volatile data storage devices described herein do not include communication media. Communication media are means of transmission of information such as modulated electromagnetic waves or modulated data signals configured to transmit, not store, information. By way of example, and not limitation, communication media includes wired communications such as sound signals transmitted to a speaker via a speaker wire, and wireless communications such as acoustic waves, radio frequency (RF) transmissions, infrared emissions, and other wireless media.

External communication devices 70 are devices that facilitate communications between computing device and either remote computing devices 80, or cloud-based services 90, or both. External communication devices 70 include, but are not limited to, data modems 71 which facilitate data transmission between computing device and the Internet 75 via a common carrier such as a telephone company or internet service provider (ISP), routers 72 which facilitate data transmission between computing device and other devices, and switches 73 which provide direct data communications between devices on a network or optical transmitters (e.g., lasers). Here, modem 71 is shown connecting computing device 10 to both remote computing devices 80 and cloud-based services 90 via the Internet 75. While modem 71, router 72, and switch 73 are shown here as being connected to network interface 42, many different network configurations using external communication devices 70 are possible. Using external communication devices 70, networks may be configured as local area networks (LANs) for a single location, building, or campus, wide area networks (WANs) comprising data networks that extend over a larger geographical area, and virtual private networks (VPNs) which can be of any size but connect computers via encrypted communications over public networks such as the Internet 75. As just one exemplary network configuration, network interface 42 may be connected to switch 73 which is connected to router 72 which is connected to modem 71 which provides access for computing device 10 to the Internet 75. Further, any combination of wired 77 or wireless 76 communications between and among computing device 10, external communication devices 70, remote computing devices 80, and cloud-based services 90 may be used. Remote computing devices 80, for example, may communicate with computing device through a variety of communication channels 74 such as through switch 73 via a wired 77 connection, through router 72 via a wireless connection 76, or through modem 71 via the Internet 75. Furthermore, while not shown here, other hardware that is specifically designed for servers or networking functions may be employed. For example, secure socket layer (SSL) acceleration cards can be used to offload SSL encryption computations, and transmission control protocol/internet protocol (TCP/IP) offload hardware and/or packet classifiers on network interfaces 42 may be installed and used at server devices or intermediate networking equipment (e.g., for deep packet inspection).

In a networked environment, certain components of computing device 10 may be fully or partially implemented on remote computing devices 80 or cloud-based services 90. Data stored in non-volatile data storage device 50 may be received from, shared with, duplicated on, or offloaded to a non-volatile data storage device on one or more remote computing devices 80 or in a cloud computing service 92. Processing by processors 20 may be received from, shared with, duplicated on, or offloaded to processors of one or more remote computing devices 80 or in a distributed computing service 93. By way of example, data may reside on a cloud computing service 92, but may be usable or otherwise accessible for use by computing device 10. Also, certain processing subtasks may be sent to a microservice 91 for processing with the result being transmitted to computing device 10 for incorporation into a larger processing task. Also, while components and processes of the exemplary computing environment are illustrated herein as discrete units (e.g., OS 51 being stored on non-volatile data storage device 51 and loaded into system memory 35 for use) such processes and components may reside or be processed at various times in different components of computing device 10, remote computing devices 80, and/or cloud-based services 90. Also, certain processing subtasks may be sent to a microservice 91 for processing with the result being transmitted to computing device 10 for incorporation into a larger processing task. Infrastructure as Code (IaaC) tools like Terraform can be used to manage and provision computing resources across multiple cloud providers or hyperscalers. This allows for workload balancing based on factors such as cost, performance, and availability. For example, Terraform can be used to automatically provision and scale resources on AWS spot instances during periods of high demand, such as for surge rendering tasks, to take advantage of lower costs while maintaining the required performance levels. In the context of rendering, tools like Blender can be used for object rendering of specific elements, such as a car, bike, or house. These elements can be approximated and roughed in using techniques like bounding box approximation or low-poly modeling to reduce the computational resources required for initial rendering passes. The rendered elements can then be integrated into the larger scene or environment as needed, with the option to replace the approximated elements with higher-fidelity models as the rendering process progresses.

In an implementation, the disclosed systems and methods may utilize, at least in part, containerization techniques to execute one or more processes and/or steps disclosed herein. Containerization is a lightweight and efficient virtualization technique that allows you to package and run applications and their dependencies in isolated environments called containers. One of the most popular containerization platforms is containerd, which is widely used in software development and deployment. Containerization, particularly with open-source technologies like containerd and container orchestration systems like Kubernetes, is a common approach for deploying and managing applications. Containers are created from images, which are lightweight, standalone, and executable packages that include application code, libraries, dependencies, and runtime. Images are often built from a containerfile or similar, which contains instructions for assembling the image. Containerfiles are configuration files that specify how to build a container image. Systems like Kubernetes natively support containerd as a container runtime. They include commands for installing dependencies, copying files, setting environment variables, and defining runtime configurations. Container images can be stored in repositories, which can be public or private. Organizations often set up private registries for security and version control using tools such as Harbor, JFrog Artifactory and Bintray, GitLab Container Registry, or other container registries. Containers can communicate with each other and the external world through networking. Containerd provides a default network namespace, but can be used with custom network plugins. Containers within the same network can communicate using container names or IP addresses.

Remote computing devices 80 are any computing devices not part of computing device 10. Remote computing devices 80 include, but are not limited to, personal computers, server computers, thin clients, thick clients, personal digital assistants (PDAs), mobile telephones, watches, tablet computers, laptop computers, multiprocessor systems, microprocessor based systems, set-top boxes, programmable consumer electronics, video game machines, game consoles, portable or handheld gaming units, network terminals, desktop personal computers (PCs), minicomputers, mainframe computers, network nodes, virtual reality or augmented reality devices and wearables, and distributed or multi-processing computing environments. While remote computing devices 80 are shown for clarity as being separate from cloud-based services 90, cloud-based services 90 are implemented on collections of networked remote computing devices 80.

Cloud-based services 90 are Internet-accessible services implemented on collections of networked remote computing devices 80. Cloud-based services are typically accessed via application programming interfaces (APIs) which are software interfaces which provide access to computing services within the cloud-based service via API calls, which are pre-defined protocols for requesting a computing service and receiving the results of that computing service. While cloud-based services may comprise any type of computer processing or storage, three common categories of cloud-based services 90 are serverless logic apps, microservices 91, cloud computing services 92, and distributed computing services 93.

Microservices 91 are collections of small, loosely coupled, and independently deployable computing services. Each microservice represents a specific computing functionality and runs as a separate process or container. Microservices promote the decomposition of complex applications into smaller, manageable services that can be developed, deployed, and scaled independently. These services communicate with each other through well-defined application programming interfaces (APIs), typically using lightweight protocols like HTTP, protobuffers, gRPC or message queues such as Kafka. Microservices 91 can be combined to perform more complex or distributed processing tasks. In an embodiment, Kubernetes clusters with containerized resources are used for operational packaging of system.

Cloud computing services 92 are delivery of computing resources and services over the Internet 75 from a remote location. Cloud computing services 92 provide additional computer hardware and storage on as-needed or subscription basis. Cloud computing services 92 can provide large amounts of scalable data storage, access to sophisticated software and powerful server-based processing, or entire computing infrastructures and platforms. For example, cloud computing services can provide virtualized computing resources such as virtual machines, storage, and networks, platforms for developing, running, and managing applications without the complexity of infrastructure management, and complete software applications over public or private networks or the Internet on a subscription or alternative licensing basis, or consumption or ad-hoc marketplace basis, or combination thereof.

Distributed computing services 93 provide large-scale processing using multiple interconnected computers or nodes to solve computational problems or perform tasks collectively. In distributed computing, the processing and storage capabilities of multiple machines are leveraged to work together as a unified system. Distributed computing services are designed to address problems that cannot be efficiently solved by a single computer or that require large-scale computational power or support for highly dynamic compute, transport or storage resource variance or uncertainty over time requiring scaling up and down of constituent system resources. These services enable parallel processing, fault tolerance, and scalability by distributing tasks across multiple nodes.

Although described above as a physical device, computing device 10 can be a virtual computing device, in which case the functionality of the physical components herein described, such as processors 20, system memory 30, network interfaces 40, NVLink or other GPU-to-GPU high bandwidth communications links and other like components can be provided by computer-executable instructions. Such computer-executable instructions can execute on a single physical computing device, or can be distributed across multiple physical computing devices, including being distributed across multiple physical computing devices in a dynamic manner such that the specific, physical computing devices hosting such computer-executable instructions can dynamically change over time depending upon need and availability. In the situation where computing device 10 is a virtualized device, the underlying physical computing devices hosting such a virtualized computing device can, themselves, comprise physical components analogous to those described above, and operating in a like manner. Furthermore, virtual computing devices can be utilized in multiple layers with one virtual computing device executing within the construct of another virtual computing device. Thus, computing device 10 may be either a physical computing device or a virtualized computing device within which computer-executable instructions can be executed in a manner consistent with their execution by a physical computing device. Similarly, terms referring to physical components of the computing device, as utilized herein, mean either those physical components or virtualizations thereof performing the same or equivalent functions.

The skilled person will be aware of a range of possible modifications of the various aspects described above. Accordingly, the present invention is defined by the claims and their equivalents.

What is claimed is:

1. A system for automated code compliance review and correction of computer-generated architectural drawings, comprising:
a computing device comprising a memory and a processor;
a two-dimensional (2D) architectural drawing manager comprising a first plurality of programming instructions stored in the memory which, when operating on the processor, causes the computing device to:
receive a verified three-dimensional (3D) architectural image;
generate a 2D architectural drawing from the verified 3D architectural image by processing the verified 3D architectural image through a machine learning algorithm which has been trained to generate 2D architectural drawings from a database of labeled training data associating 3D architectural images with their 2D architectural drawing counterparts; and
output the 2D architectural drawing;
a code compliance and correction module comprising a second plurality of programming instructions stored in the memory which, when operating on the processor, causes the computing device to:
receive the 2D architectural drawing from the 2D architectural drawing manager;
select a jurisdiction-specific code set from a multi-jurisdiction code database based on a project location;
process the 2D architectural drawing and the jurisdiction-specific code set through a compliance machine learning algorithm which has been trained on a database of labeled training data associating 2D architectural drawings with jurisdiction-specific code compliance determinations, to generate a structured violation report identifying each code violation by violation type, applicable code section, location within the 2D architectural drawing, and one or more suggested corrections;
generate an annotated 2D architectural drawing in which each identified violation is spatially marked at its location within the 2D architectural drawing;
generate a corrected 2D architectural drawing based on the structured violation report; and
re-submit the corrected 2D architectural drawing to the compliance machine learning algorithm and iterate until the corrected 2D architectural drawing satisfies all requirements of the jurisdiction-specific code set.

2. The system of claim 1, wherein the code compliance and correction module further comprises programming instructions which, when operating on the processor, cause the computing device to identify conflicts between overlapping requirements of two or more building codes within the jurisdiction-specific code set and to generate a conflict report for resolution prior to processing the 2D architectural drawing through the compliance machine learning algorithm.

3. The system of claim 1, wherein the structured violation report classifies each identified violation as critical or non-critical, and wherein the code compliance and correction module iterates until all critical violations are resolved, with non-critical violations flagged for acceptance by a user.

4. The system of claim 1, wherein, where the structured violation report identifies a violation requiring a design change, the code compliance and correction module transmits corrected structured requirements to a three-dimensional (3D) image generation manager for regeneration of the verified 3D architectural image and subsequent regeneration of the 2D architectural drawing.

5. The system of claim 1, wherein, upon the corrected 2D architectural drawing satisfying all requirements of the jurisdiction-specific code set, the code compliance and correction module generates a compliance certification associated with the corrected 2D architectural drawing.

6. The system of claim 3, wherein the annotated 2D architectural drawing is presented to a user interface together with the structured violation report, and wherein the code compliance and correction module receives user input comprising acceptance of one or more non-critical violations or a selection from among the one or more suggested corrections.

7. The system of claim 1, wherein the database of labeled training data on which the compliance machine learning algorithm has been trained comprises 2D architectural drawings annotated with identified building code violations, applicable code sections, and spatial locations of each violation within the drawings.

8. A method for automated code compliance review and correction of computer-generated architectural drawings, comprising the steps of:
using a two-dimensional (2D) architectural drawing manager operating on a computing device comprising a memory and a processor to:
receive a verified three-dimensional (3D) architectural image;
generate a 2D architectural drawing from the verified 3D architectural image by processing the verified 3D architectural image through a machine learning algorithm which has been trained to generate 2D architectural drawings from a database of labeled training data associating 3D architectural images with their 2D architectural drawing counterparts;
output the 2D architectural drawing; and
using a code compliance and correction module operating on the computing device to:
receive the 2D architectural drawing from the 2D architectural drawing manager;
select a jurisdiction-specific code set from a multi-jurisdiction code database based on a project location;
process the 2D architectural drawing and the jurisdiction-specific code set through a compliance machine learning algorithm which has been trained on a database of labeled training data associating 2D architectural drawings with jurisdiction-specific code compliance determinations, to generate a structured violation report identifying each code violation by violation type, applicable code section, location within the 2D architectural drawing, and one or more suggested corrections;
generate an annotated 2D architectural drawing in which each identified violation is spatially marked at its location within the 2D architectural drawing;
generate a corrected 2D architectural drawing based on the structured violation report; and
re-submit the corrected 2D architectural drawing to the compliance machine learning algorithm and iterate until the corrected 2D architectural drawing satisfies all requirements of the jurisdiction-specific code set.

9. The method of claim 8, further comprising the step of using the code compliance and correction module to identify conflicts between overlapping requirements of two or more building codes within the jurisdiction-specific code set and to generate a conflict report for resolution prior to processing the 2D architectural drawing through the compliance machine learning algorithm.

10. The method of claim 8, further comprising the step of using the code compliance and correction module to transmit, where the structured violation report identifies a violation requiring a design change, corrected structured requirements to a three-dimensional (3D) image generation manager for regeneration of the verified 3D architectural image and subsequent regeneration of the 2D architectural drawing.
